(19) United States
(12) Patent Application Publication
(10) Pub. No.: US 2011/0316811 A1
(43) Pub. Date: Dec. 29, 2011

(54) INPUT DEVICE OF PORTABLE ELECTRONIC APPARATUS, CONTROL METHOD OF INPUT DEVICE, AND PROGRAM

(76) Inventor: Takeharu Kitagawa, Tokyo (JP)

(21) Appl. No.: 13/255,988

(22) PCT Filed: Mar. 16, 2010
(86) PCT No.: PCT/JP2010/054381

§ 371 Date: Sep. 12, 2011

(30) Foreign Application Priority Data
Mar. 17, 2009 (JP) 2009-064791

(51) Int. Cl. G06F 3/045; G06F 3/041

(52) U.S. Cl. 345/174; 345/173

(57) ABSTRACT

An input device for a portable electronic apparatus comprises: a display unit that displays a plurality of input keys; a touch panel unit including at least one touch panel provided on the display unit; and a control unit that controls and causes the display unit to display a second input key substantially at a same location as a first input key already displayed on the display unit in response to a predetermined input detected by the touch panel unit.

### TECHNICAL FIELD

### Reference to Related Application

The present invention is based upon and claims the benefit of the priority of Japanese Patent Application No. 2009-064791 (filed on Mar. 17, 2009), the disclosure of which is incorporated herein in its entirety by reference.

The present invention relates to an input device of a portable electronic apparatus, a control method of the input device, and a program.

### BACKGROUND

Functions mainly used in early cellular phones were telephone call and registration of a telephone number. When these functions are used, only an input operation of numbers or simple characters is needed. Accordingly, it was enough for an input device of the cellular phones to have a ten-key alone.

However, since functions for a mail, menu display, and the Internet were given to the cellular phones and an input operation has also become diversified, an input device of recent cellular phones includes a cross key and a menu key.

Some cellular phones include a jog dial for moving a cursor in a predetermined direction as a direction key of the cross key. Further, some cellular phones include an analog pointer for moving a cursor in an arbitrary direction as a center key of the cross key in order to improve convenience of an input operation and thereby reduce an input time.

Recently, functions for a mail, menu display, and the Internet have become further complex in a cellular phone, and functions for a game, a camera, music reproduction, and TV reception have also been added to the cellular phone. Accordingly, an input device of the cellular phone is needed to further improve operability of an input operation.

FIG. 16A is a plan view of a cellular phone described in Patent Document 1. Referring to FIG. 16B, a cross key 150 is disposed closer to a first case 131 than the center of a key arrangement surface of a second case 130. Referring to FIG. 16C, a ten-key 160 is disposed on the key arrangement surface of the second case 130 on an opposite side of the first case 131 with respect to the cross key 150. Referring to FIG. 16D, a menu key 180 of this cellular phone is arranged around the cross key 150 on the key arrangement surface of the second case 130.

Referring to FIG. 17A, the cross key 150 includes a round center key 151 and a direction key 154. The center key 151 is an analog pointer 153 and is also a determination key 152. The direction key 154 includes an “up” key 155, a “down” key 156, a “left” key 157, and a “right” key 158.

Referring to FIG. 17B, the ten-key 160 includes a call key 171, a clear key 172, a power key 173, a “1” key 161, a “2” key 162, a “3” key 163, a “4” key 164, a “5” key 165, a “6”key 166, a “7” key 167, an “8” key 168, a “9” key 169, a “0” key 170, a “*” key 174, and a “#” key 175.

The menu key 180 includes a mail key 181, an Internet key 182, a first menu key 183, and a second menu key 184.

FIG. 18A is a sectional view of the cross key 150 (showing a section a1-a2 in FIG. 17A). The cellular phone includes the cross key 150, the center key 151, the direction key 154, a permanent magnet 114, a Hall effect device 142, an elastomer member 120, projections 193, metal domes 192, a first board 191, and a second board 141.

The permanent magnet 114 is provided in an inside of the center key 151. The Hall effect device 142 detects a position of the permanent magnet 114. The elastomer member 120 elastically connects the center key 151 and the direction key 154, and includes a function of preventing dust and water. Each projection 193 projects from the elastomer member 120 toward an inside of the second case 130. Each metal dome 192 performs a contact operation by being deformed by the projection 193. The metal domes 192 are disposed on the first board 191. The Hall effect device 142 is disposed on the second board 141.

FIG. 18B is a sectional view of the ten-key 160 and the menu key 180 (showing a section a3-a4 in FIG. 17C). The cellular phone includes the elastomer member 120, the projections 193, the metal domes 192, and the first board 191.

The elastomer member 120 elastically connects the ten-key 160 and the menu key 180, and includes the function of preventing dust and water. Each projection 193 projects from the elastomer member 120 toward the inside of the second case 130. Each metal dome 192 performs the contact operation by being deformed by the projection 193. The metal domes 192 are disposed on the first board 191. The elastomer member 120 in FIG. 18A and the elastomer member 120 in FIG. 18B are connected.

Referring to FIG. 19A, a pointer 133 displayed on a display screen 132 of the first case 131 is moved, using the center key 151. Referring to FIG. 19B, when the center key 151 is moved in a diagonally upward left direction, the pointer 133 displayed on the display screen 132 moves in a diagonally upward left direction. Referring to FIG. 19C, when the center key 151 is depressed, a selected item is determined on the display screen 132.

When the center key 151 is used as the analog pointer 153, the center key 151 is slid in an arbitrary direction in parallel with the key arrangement surface of the second case 130. At this point, the position of the permanent magnet 114 is detected by the Hall effect device 142, and the pointer 133 displayed on the display screen 132 of the first case 131 is moved in an arbitrary direction.

When the center key 151 is used as the determination key 152, the center key 151 is depressed. At this point, the metal dome 192 is deformed to perform a contact operation. Then, a selected item is determined on the display screen 132 of the first case 131.

When the direction key 154 is used, the direction key 154 is depressed. At this point, the metal dome 192 is deformed to perform a contact operation. A cursor is moved in a predetermined direction on the display screen 132 of the first case 131.

When the ten-key 160 is used, the ten-key 160 is depressed. At this point, the metal dome 192 is deformed to perform a contact operation. A number or a character is input on the display screen 132 of the first case 131.

When the menu key 180 is used, the menu key 180 is depressed. At this point, the metal dome 192 is deformed to perform a contact operation. A function is thereby selected on the display screen 132 of the first case 131.

Patent Document 1: JP Patent Kokai Publication No. JP-P-2004-62447A

### SUMMARY

The entire disclosure of Patent Document listed above is incorporated herein by reference thereto.

The following analyses are given by the inventor of the present invention. The structure shown above has the following problems.

First, there is a problem that a time needed for an input operation is long. FIG. 20A is a diagram showing a state where the “5” key 165 of the ten-key 160 is input. FIG. 20B is a diagram showing a state where the center key 151 is depressed (or the determination key 152 is input). When a character is input to a text of a mail, for example, the character is selected on the key arrangement surface of the second case 130, using the ten-key 160. Then, a thumb is moved to the center key 151 to determine the character to be input. Accordingly, when a distance LO between the “5” key 165 and the center key 151 is long, a moving distance of the thumb is long. It therefore takes a long time to input the character.

There is also a problem that it is difficult to slide the center key 151 (or to operate the analog pointer 153). FIG. 21A is a diagram showing a state where the center key 151 is slide-operated. When the skin of the thumb is dry as in winter, the friction between the thumb and the center key 151 is small. When the center key 151 is slid (or is operated as the analog pointer 153) in such a case, there is the problem that the thumb may slip over the center key 151, and the slide operation cannot be performed well.

Further, there is a problem that an input operation of a key provided at an end portion 200 of the second case 130 is difficult. Referring to FIG. 22A, when the input operation is performed with an index finger placed on a corner of the second case 130 and the key provided at the end portion 200 is depressed, the thumb cannot fully reach the key. Depression of the key therefore becomes difficult. Referring to FIG. 22B, when the input operation is performed with the index finger supporting a lower side of the second case 130 and a key provided at the end portion 200 of the second case 130 is depressed, the thumb cannot fully reach the key. Depression of the key therefore becomes difficult.

Then, there is a need in the art to provide an input device of a portable electronic apparatus, a control method of the input device, and a program that reduce the area of a region in which input keys are disposed in an input device of a portable electronic apparatus.

According to a first aspect of the present invention, there is provided an input device, comprising: a display unit that displays a plurality of input keys; a touch panel unit including at least one touch panel provided on the display unit; and a control unit that controls and causes the display unit to display a second input key substantially at a same location as a first input key already displayed on the display unit in response to a predetermined input detected by the touch panel unit.

According to a second aspect of the present invention, there is provided a portable electronic apparatus comprising the above-mentioned input device.

According to a third aspect of the present invention, there is provided a control method of an input device for a portable electronic apparatus comprising: by a computer, detecting a predetermined input through a touch panel unit including at least one touch panel provided on a display unit that displays input keys; and displaying a second input key substantially at a same location as a first input key already displayed on the display unit.

According to a fourth aspect of the present invention, there is provided a program of controlling an input device for a portable electronic apparatus, the program causing a computer to execute: detecting a predetermined input through a touch panel unit including at least one touch panel provided on a display unit that displays input keys; and displaying a second input key substantially at a same location as a first input key already displayed on the display unit. The program may be recorded on a non-transient computer-readable recording medium.

The present invention provides the following advantage, but not restricted thereto. According to the input device of a portable electronic apparatus, the control method of the input device, and the program of the present invention, the area of a region where the input keys are disposed can be reduced.

### BRIEF DESCRIPTION OF THE DRAWINGS

FIG. 1 is a block diagram showing a configuration of an input device according to an exemplary embodiment;

FIGS. 2A and 2B include a sectional view and an exploded view of a cellular phone according to a first example;

FIGS. 3A to 3C include plan views of the cellular phone according to the first example;

FIGS. 4A to 4C include diagrams for explaining an effect of the cellular phone according to the first example;

FIGS. 5A to 5C include plan views of the cellular phone according to the first example;

FIGS. 6A to 6C include diagrams for explaining effects of the cellular phone according to the first example;

FIGS. 7A to 7F include diagrams for explaining operations when a ten-key of the cellular phone according to the first example is operated;

FIGS. 8A to 8E include diagrams for explaining operations where a determination key of the cellular phone according to the first example is operated;

FIGS. 9A to 9F include diagrams for explaining operations when a direction key of the cellular phone according to the first example is operated;

FIGS. 10A to 10F include diagrams for explaining operations when a menu key of the cellular phone according to the first example is operated;

FIGS. 11A and 11B is a sectional view and an exploded view of a cellular phone according to a second example;

FIGS. 12A to 12F include diagrams for explaining operations when a ten-key of the cellular phone according to the second example is operated;

FIGS. 13A to 13E include diagrams for explaining operations when a determination key of the cellular phone according to the second example is operated;

FIGS. 14A to 14F include diagrams for explaining operations when a direction key of the cellular phone according to the second example is operated;

FIGS. 15A to 15F include diagrams for explaining operations when a menu key of the cellular phone according to the second example is operated;

FIGS. 16A to 16D include plan views of a related art cellular phone;

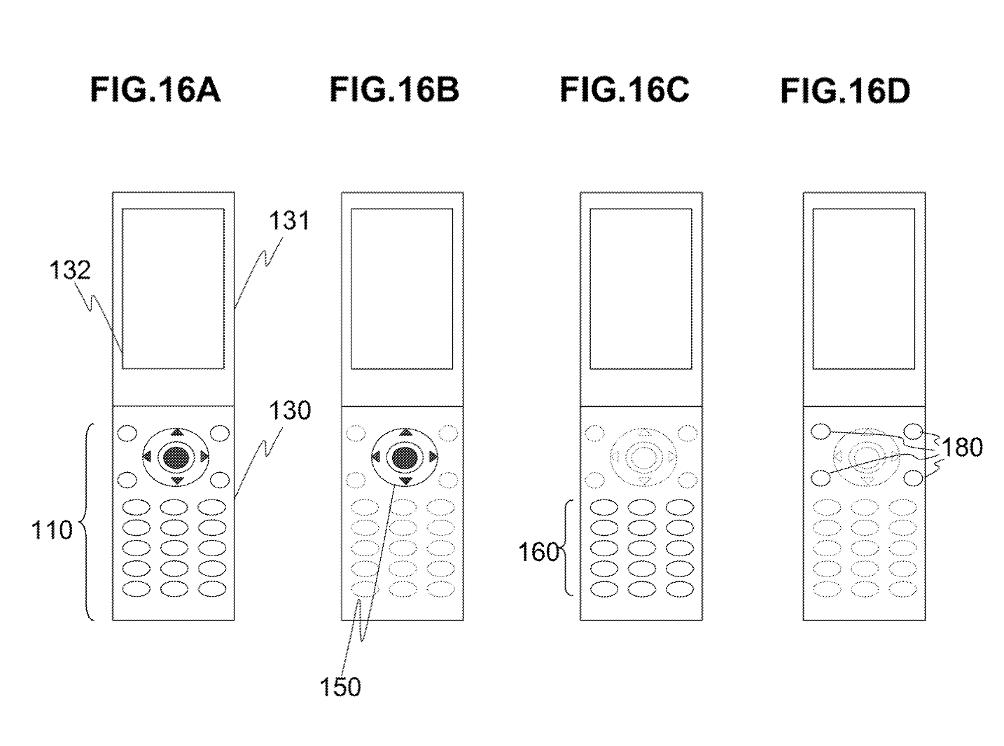

FIGS. 17A to 17C include includes plan views of the related art cellular phone;

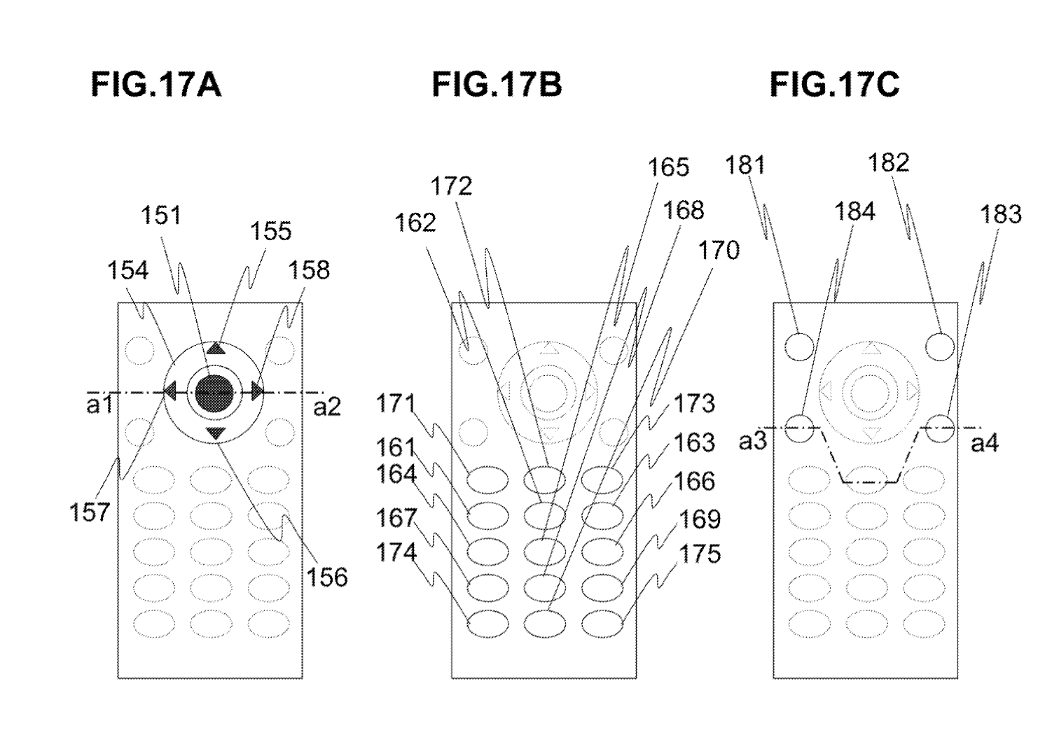

FIGS. 18A and 18B include sectional views of the related art cellular phone;

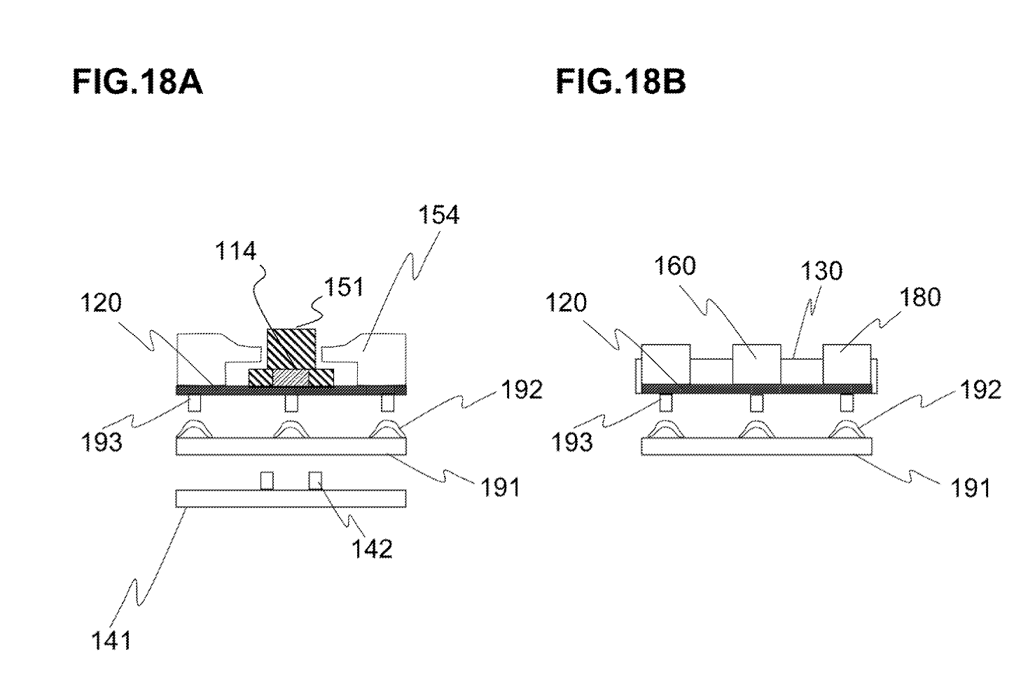

FIGS. 19A to 19C include diagrams for explaining an operation of a center key of the related art cellular phone;

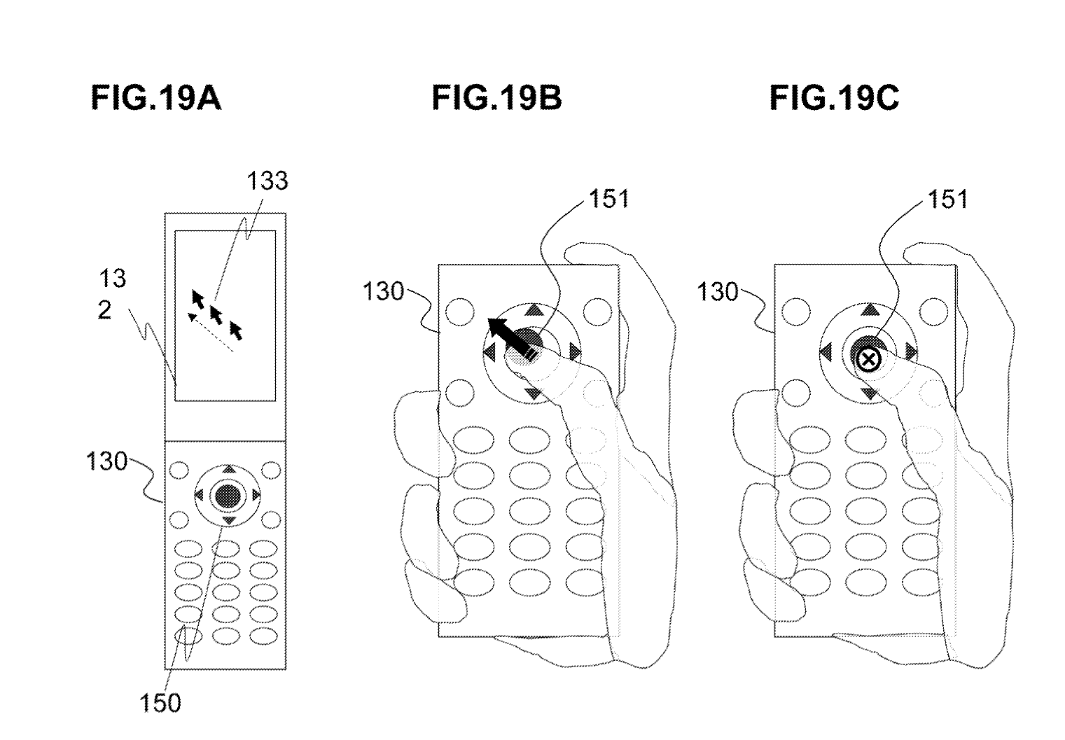

FIGS. 20A and 20B include diagrams for explaining a problem encountered when a key of the related art cellular phone is operated;

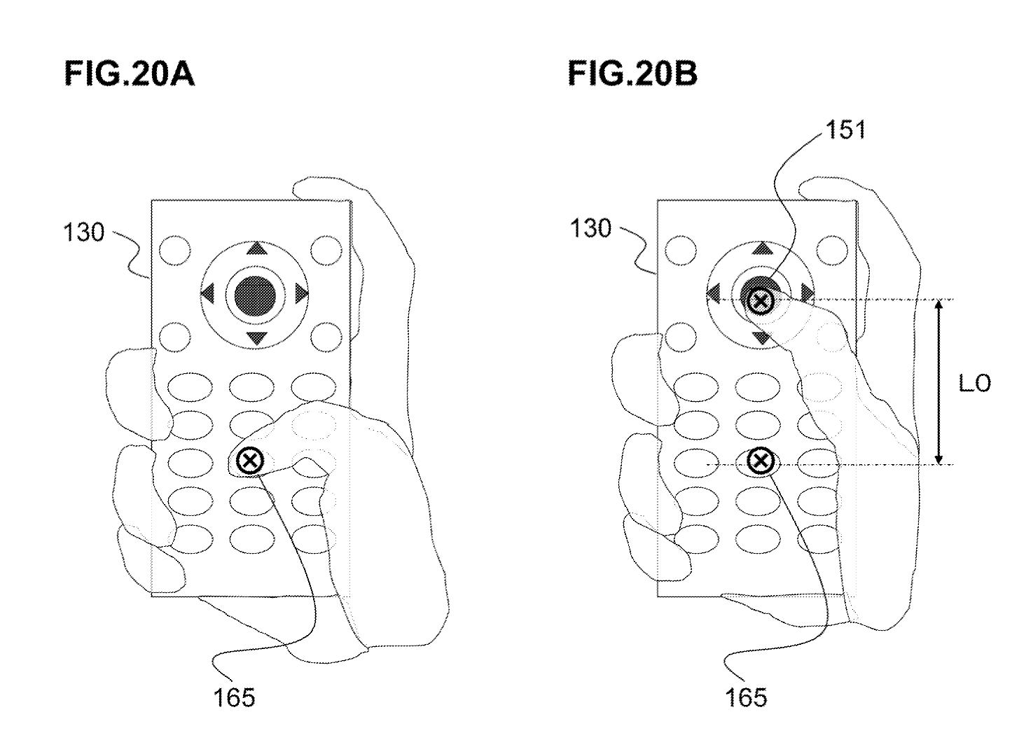

FIGS. 21A and 21B include diagrams for explaining a problem encountered when a center key of the related art cellular phone is slide-operated; and

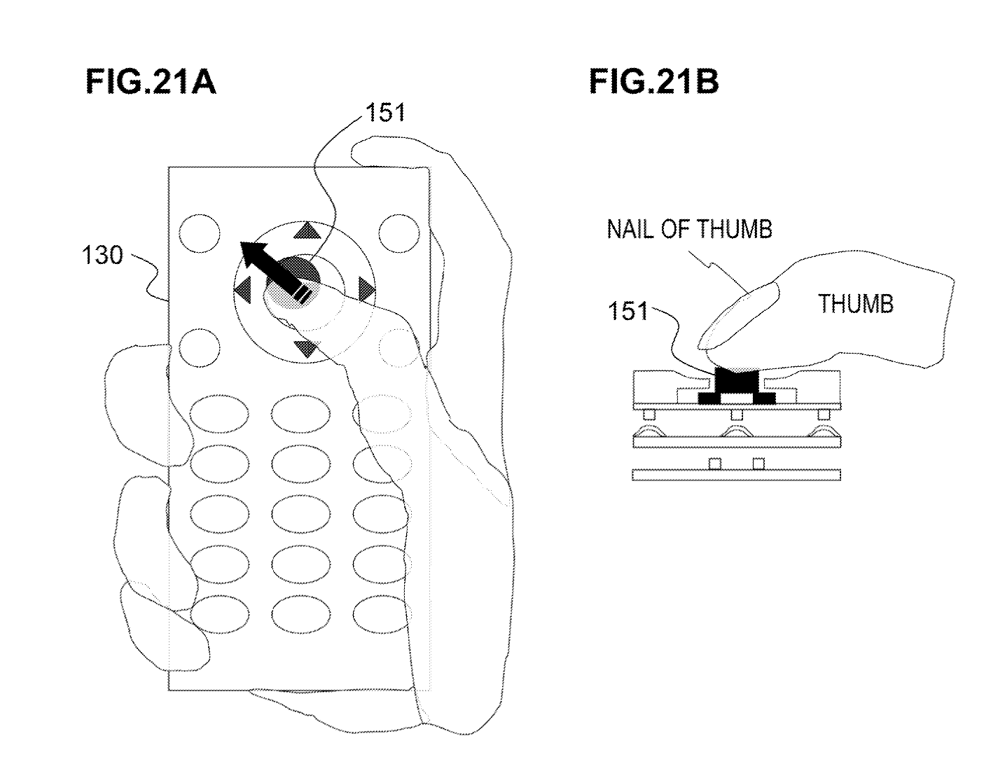

FIGS. 22A and 22B include diagrams for explaining a problem encountered when a key provided at an end of the related art cellular phone is operated.

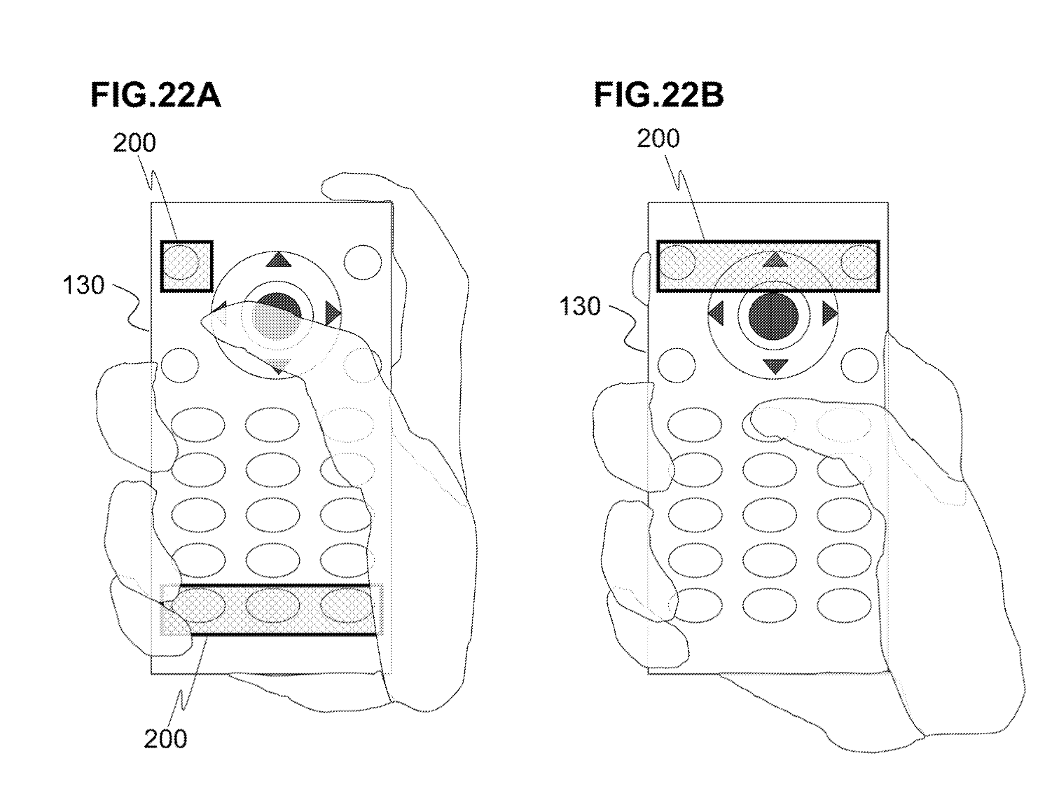

### PREFERRED MODES

In the present disclosure, there are various possible modes, which includes the following, but not restricted thereto. Preferably, an input device in a first development mode is the input device according to the first aspect.

In an input device in a second development mode, the predetermined input may be a touching or pressing on a predetermined location of the touch panel unit.

In an input device in a third development mode, the predetermined input may be continuation of the touching or pressing force on the predetermined location for a predetermined period of time.

In an input device in a fourth development mode, the predetermined input may comprise touching or pressing successively applied from a first predetermined location to a second predetermined location of the touch panel unit.

In an input device in a fifth development mode, the display unit may perform superimposed display of the second input key on the first input key.

In an input device in a sixth development mode, the display unit may delete display of the first input key and may display the second input key.

Preferably, in an input device in a seventh development mode, the touch panel unit includes a first touch panel based on an electrostatic capacitance system.

In an input device in an eighth development mode, the control unit may control content of display on the display unit, based on an electrostatic capacitance detected by the first touch panel.

Preferably, in an input device in a ninth development mode, the control unit determines selection of one of the input keys based on the electrostatic capacitance detected by the first touch panel.

Preferably, in an input device in a tenth development mode, the touch panel unit includes a second touch panel of a pressure-sensitive system between the first touch panel and the display unit.

In an input device in an eleventh development mode, the control unit may control the content of display on the display unit based on the electrostatic capacitance detected by the first touch panel and may determine selection of one of the input keys based on a change in pressure detected by the second touch panel.

Preferably, in an input device in a twelfth development mode, the first input key is a ten-key, and the second input key includes at least one of a determination key, a direction key, and a menu key.

Preferably, a portable electronic apparatus in a thirteenth development mode is the portable electronic apparatus according to the second aspect.

Preferably, a portable electronic apparatus in a fourteenth development mode further comprises an elastic member connecting a main body of the apparatus and the input device, and the input device can be slid in a direction parallel to an installation surface of the input device.

In a portable electronic apparatus in a fifteenth development mode, the elastic member may be an elastomer member.

Preferably, a portable electronic apparatus in a sixteenth development mode comprises a position detection unit that detects a position of the input device.

In a portable electronic apparatus in a seventeenth development mode, the position detection unit may include a Hall effect device that detects a position of a magnet provided for the input device.

Preferably, a control method of an input device in an eighteenth development mode is the control method according to the third aspect.

### Exemplary Embodiments

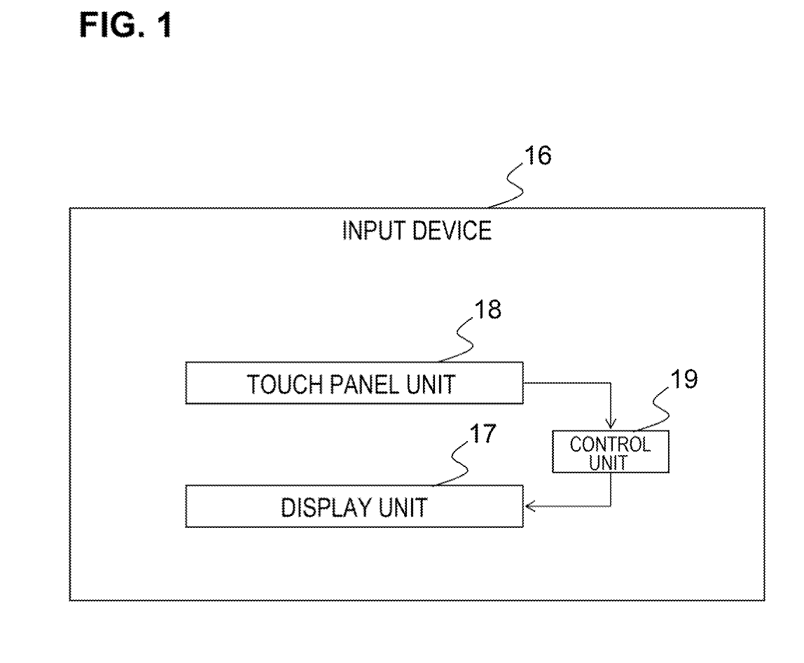

An input device according to an exemplary embodiment will be described with reference to the drawings. FIG. 1 is a block diagram showing a configuration of the input device according to this exemplary embodiment.

Referring to FIG. 1, an input device 16 comprises a display unit 17, a touch panel unit 18, and a control unit 19. The display unit 17 displays a plurality of input keys. The touch panel unit 18 comprises at least one touch panel provided on the display unit 17. The control unit 19 controls the display unit 17 so that a second input key is displayed substantially at a same location as a first input key already displayed on the display unit, in response to a predetermined input to the touch panel unit 18.

According to the input device 16, the area of a region where the input keys are disposed can be reduced. The display unit 17 is controlled by the control unit 19 so that the second input key is displayed substantially at a same location as the first input key already displayed on the display unit 17. Accordingly, a user can perform an input operation to the input device 16 using the first and second input keys that are displayed substantially at the same location on the display unit 17. That is, the user can complete the input operation for a plurality of the input keys almost without moving a finger, a touch pen, or the like.

The predetermined input may be a touch or a pressing force on a predetermined location of the touch panel unit 18. Alternatively, the predetermined input may be continuation of a touching or pressing on the predetermined location for a predetermined period of time. Further, the predetermined input may be a continuous touching or pressing from one to another of predetermined locations of the touch panel unit 18.

The display unit 17 may superimpose the second input key on the first input key for display. The display unit 17 may delete display of the first input key and may display the second input key. With this arrangement, the user can be informed of the state of the input device 16 capable of receiving input of the second input key.

Preferably, the touch panel unit 18 comprises a first touch panel based on an electrostatic capacitance system. In this case, the control unit 19 may control display content of the display unit 17, based on an electrostatic capacitance detected by the first touch panel. The control unit 19 may determine selection of one of the input keys, based on the electrostatic capacitance detected by the first touch panel.

Preferably, the touch panel unit 18 includes a second touch panel of a pressure sensitive system between the first touch panel and the display unit 17. In this case, the control unit 19 may control display content of the display unit 17, based on an electrostatic capacitance detected by the first touch panel and may determine selection of one of the input keys, based on a change in pressure detected by the second touch panel. By providing a plurality of touch panels, variation of an input operation by the user can be increased. By providing the touch panel of the electrostatic capacitance system and the touch panel of the pressure sensitive system for the touch panel unit 18, as an example, the input device 16 can detect a pressing (force) of the user on the touch panel as well as a touch of the user on the touch panel.

Preferably, the first input key is a ten-key, and the second input key comprises at least one of a determination key, a direction key, and a menu key. As an example, the display unit 17 may display the first key as a default and may display the second key when the predetermined input has been performed. Preferably, the display unit 17 displays one of the input keys with a high frequency of use as a default.

Preferably, a portable electronic apparatus includes the input device 16. Preferably, the portable electronic apparatus further includes an elastic member connecting a main body and the input device 16. In this case, the input device 16 can be slid within a plane parallel to a surface on which the input device 16 is installed. The elastic member may be elastomer member.

Preferably, the portable electronic apparatus further includes a position detection unit that detects a position of the input device 16 when the input device 16 is slid. The position detection unit may include a Hall effect device that detects a position of a magnet provided for the input device 16.

### FIRST EXAMPLE

### Configuration

A description will be given to an example where an input device according to the present invention has been applied to a cellular phone, with reference to drawings.

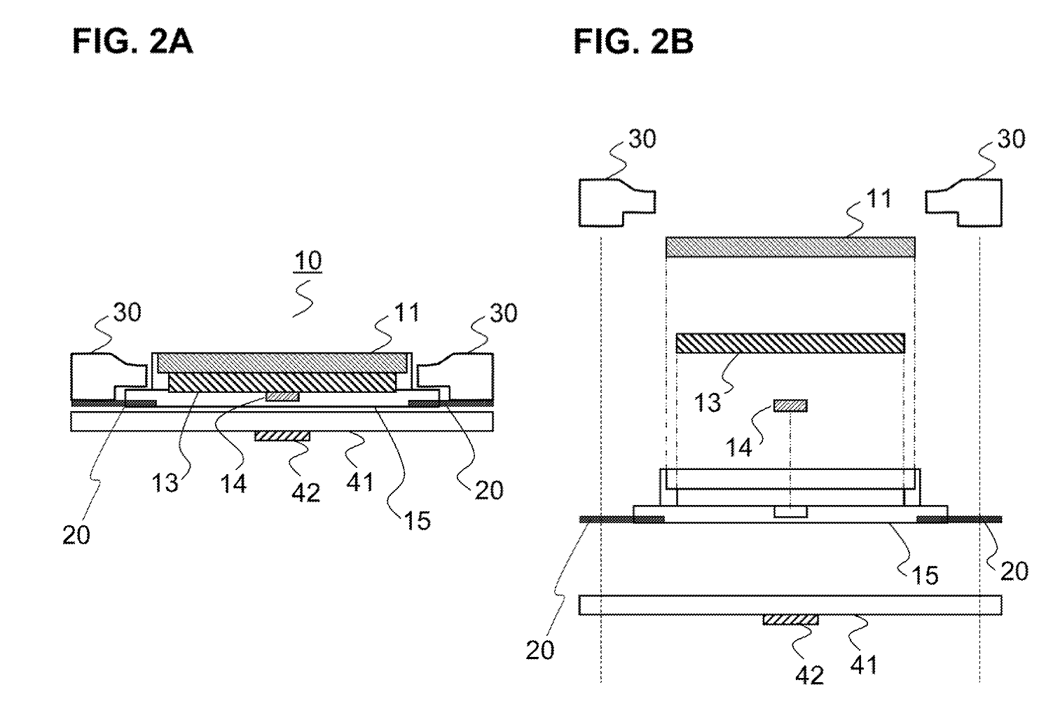

FIGS. 2A and 2B includes a sectional view (FIG. 2A) and an exploded view (FIG. 2B) of the cellular phone for which the input device according to this example has been provided. An input device is provided inside a second case 30. The input device 10 comprises a first touch panel 11, a display unit 13, a permanent magnet 14, and a housing 15.

An elastomer member 20 elastically connects the second case 30 and the housing 15 and functions to prevent dust and water. The first touch panel 11, the display unit 13, and the permanent magnet 14 are disposed in the housing 15. When a thumb touches the first touch panel 11, the first touch panel 11 performs a contact operation. The display unit 13 can display a ten-key 60, a determination key 52, a direction key 54, and a menu key 80. The permanent magnet 14 is provided for enabling position detection of an analog pointer 53. A Hall effect device 42 is provided on a second board 41, and detects a position of the analog pointer 53, based on the permanent magnet 14 within the housing 15.

The housing 15 and the elastomer member 20 are heat welded. The elastomer member 20 and the second board 41 are fixed to the second case, using screws. Accordingly, a center key 51 and the second case 30 are elastically connected by the elastomer member 20. A connecting portion using the elastomer member 20 therefore functions to prevent dust and water between the center key 51 and the second case 30. The input device 10 can be slide-operated in an arbitrary direction parallel to the key arrangement surface of the second case 30.

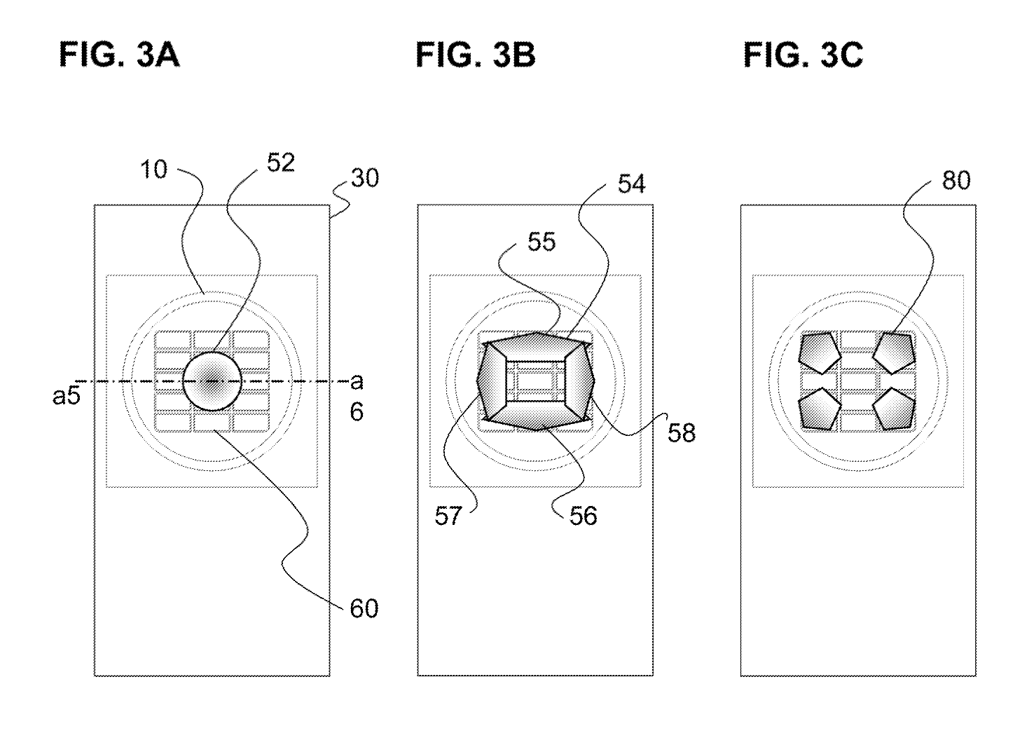

FIGS. 3A to 3C include plan views of the cellular phone for which the input device 10 according to this example has been provided. Referring to FIGS. 3A to 3C, the input device 10 is disposed on an upper side (side of a first case) of the center of the key arrangement surface of the second case 30 on the pages of FIGS. 3A to 3C. The ten-key 60, the determination key 52, the direction key 54, and the menu key 80 capable of being displayed on the display unit 13 are displayed on the display unit 13. The center of the input device 10 is disposed at almost a same location as the center of the ten-key 60 on the key arrangement surface of the second case 30. The input device 10 is a large-sized key switch that combines functions of the ten-key 60, the determination key 52, the direction key 54, and the menu key 80.

The input device 10 functions as the analog pointer 53 and the determination key 52. The direction key 54 includes an “up” key 55, a “down” key 56, a “left” key 57, and a “right” key 58. The ten-key 60 includes a call key 71, a clear key 72, a power key 73, a “1” key 61, a “2” key 62, a “3” key 63, a “4” key 64, a “5” key 65, a “6”key 66, a “7” key 67, a “8” key 68, a “9” key 69, a “0” key 70, a “s” key 74, and a “#” key 75. The menu key 80 includes a mail key 81, an Internet key 82, a first menu key 83, and a second menu key 84.

### Operations

Next, a description will be directed to operations when operating input keys.

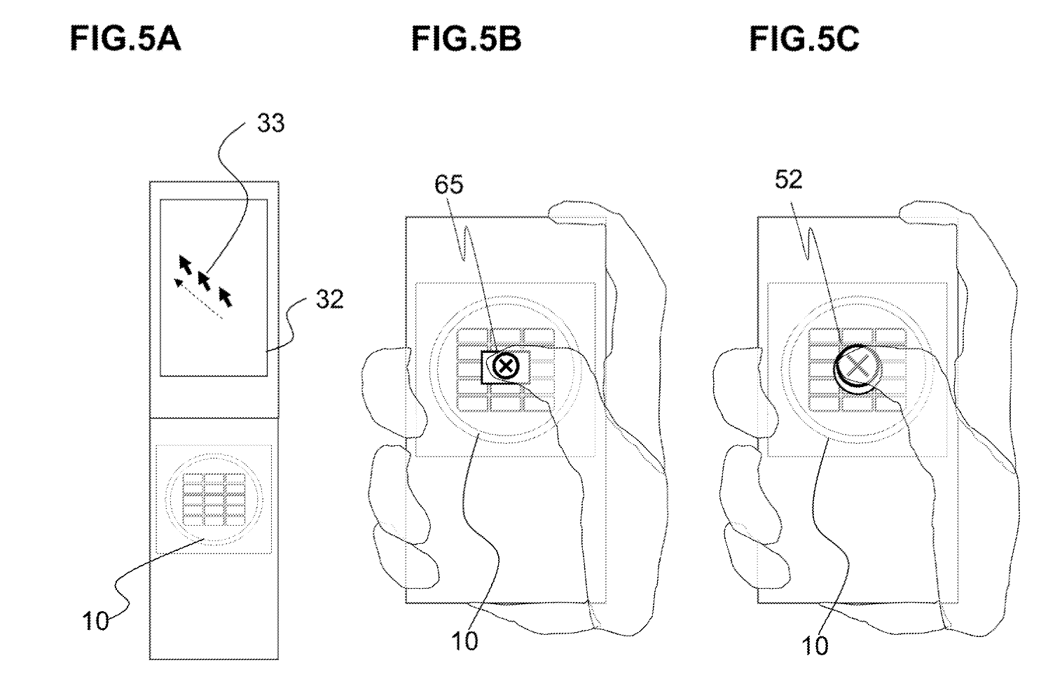

FIGS. 5A to 10F are diagrams for explaining the operations when operating the input keys of the cellular phone in the first example. FIG. 5A is a plan view of the cellular phone in the first example. FIGS. 3A, 3B, 3C, 5B, 5C, 6A, 6B and 6C are plan views of the second case 30 on which the keys are arranged, out of the cases of the cellular phone in this example. FIG. 2A is the sectional view of the input device 10 of the cellular phone in the first example. FIG. 2B is the exploded view of FIG. 2A.

### Input of Ten-key

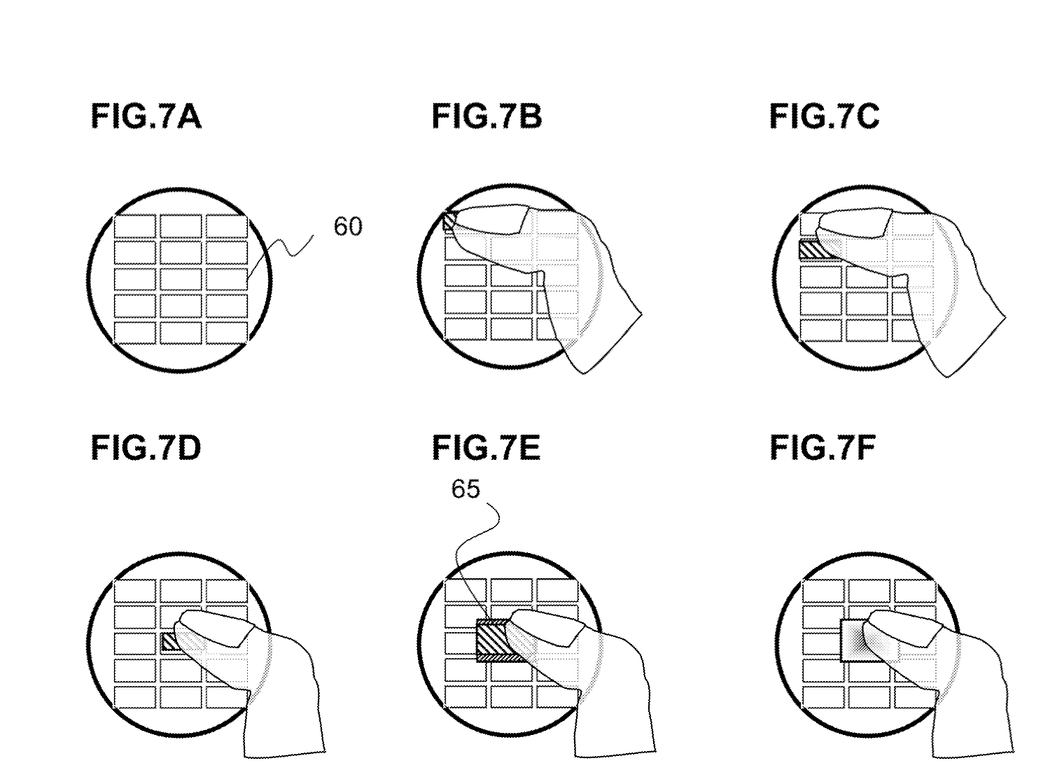

The operations when inputting the “5” key 65 in FIG. 5B will be described. The “5” key 65 is a square key located at the center of the ten-key 60 in FIGS. 5B and FIGS. 7A to 7F. When the ten-key 60 is used, the ten-key 60 is displayed by a ten-key display trigger (as shown in FIG. 7A). Next, when a thumb touches the ten-key 60, the first touch panel 11 of an electrostatic capacitance system performs a contact operation by detecting static electricity of the thumb. Then, a cursor indicating selection of an input key near the location of the touch is displayed (as shown in FIG. 7B). Next, when the thumb is moved while contacting the touch panel 11, the cursor is also moved together with the movement of the thumb (as shown in FIG. 7C). When the thumb is moved to the “5” key 65, the cursor is displayed for the “5” key 65 (as shown in FIG. 7D). Next, when the state of the touch is held without moving the thumb, enlarged display of the key area of the “5” key 65 is performed by a state holding trigger. Then, the cursor is also displayed (as shown in FIG. 7E). Next, when the state of the touch is held without moving the thumb, input of the “5” key 65 is determined by the state holding trigger (as shown in FIG. 7F). The number or character is input to a display screen 32 of a first case 31 by the above-mentioned operations.

When the area of the display unit 13 for displaying the ten-key 60 is small, the area of each input key is reduced. When the area of each input key is small, the cursor indicating selection of the key cannot be visually recognized due to the presence of the thumb. Erroneous input may be thereby brought about. Then, when the input key having a small area is selected, enlarged display of the area of the input key is performed. Visibility can be thereby improved, and erroneous input can be thereby prevented.

### Input of Determination Key

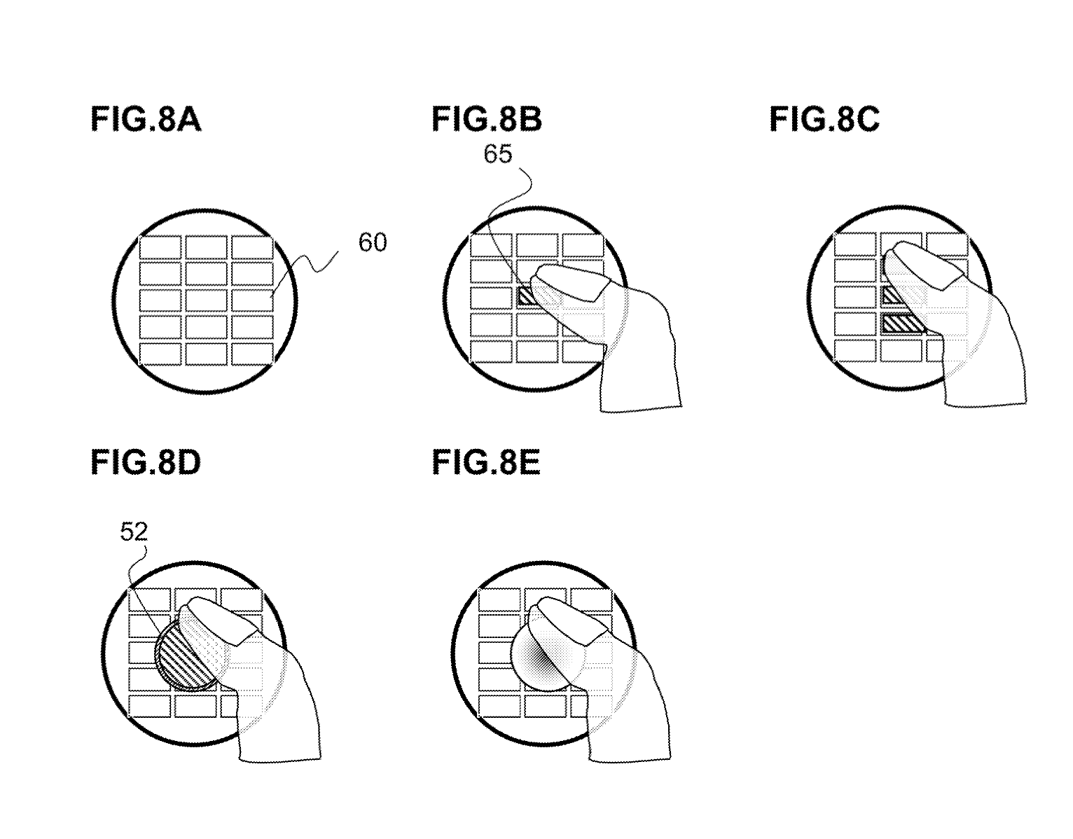

The operations when inputting the determination key 52 in FIG. 5C will be described. Referring to FIGS. 5C and FIGS. 8A to 8E, the determination key 52 is a round key displayed in the vicinity of the center of the ten-key 60. When the determination key 52 is used, the ten-key 60 is displayed by the ten-key display trigger (as shown in FIG. 8A). Next, when the thumb touches a location in the vicinity of the “5” key 65 of the ten-key 60, the first touch panel 11 of the electrostatic capacitance system performs a contact operation by detecting static electricity of the thumb. Then, the cursor indicating selection of the input key is displayed for the “5” key 65 (as shown in FIG. 8B). Next, when the whole belly of the thumb is touched on the touch panel 11 in the vicinity of the “5” key 65, the cursor is displayed for each of the input keys in the vicinity of the “5” key 65 as well (as shown in FIG. 8C). Next, when the state of the touch is held without moving the thumb, the determination key 52 is displayed over a location around the “5” key 65 by the state holding trigger, and a cursor is also displayed (as shown in FIG. 8D). Next, when the state of the touch is held without moving the thumb, input of the determination key 52 is determined by the state holding trigger (as shown in FIG. 8E). Selection of the number or character is determined for the display screen 32 of the first case 31 by the above-mentioned operations.

### Input of Direction Key

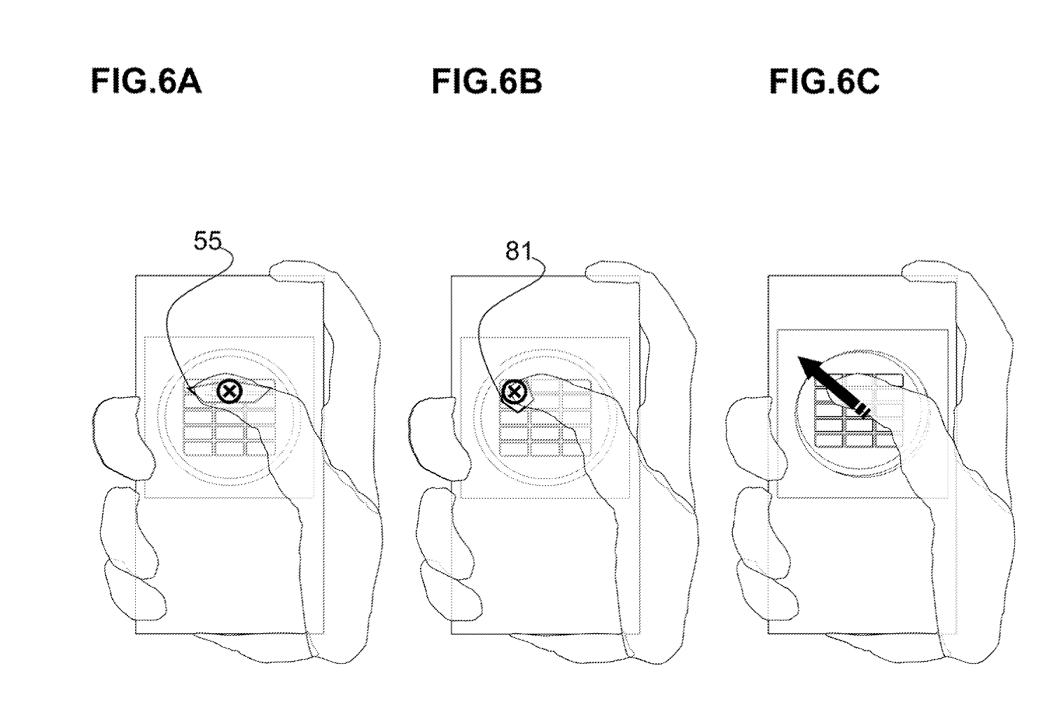

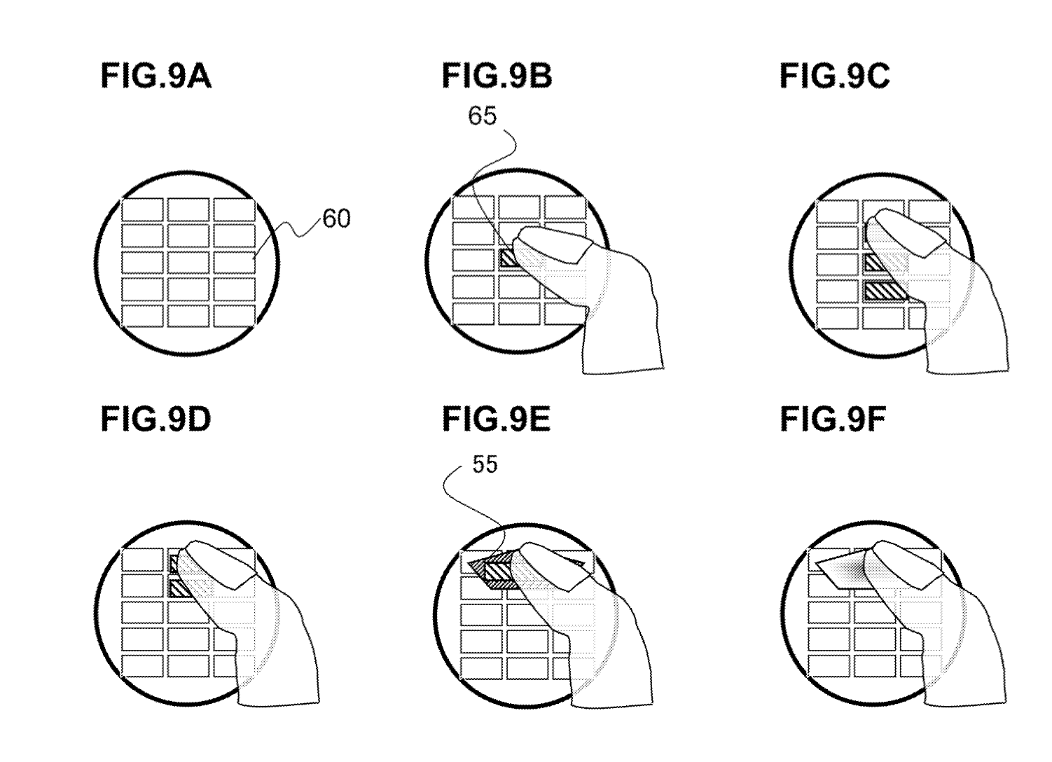

The operations when inputting the “up” key 55 of the direction key 54 shown in FIG. 6A will be described. The “up” key 55 is a pentagon-shaped key displayed at an upper end of the ten-key 60 in FIGS. 6A and FIGS. 9A to 9F. When the direction key 54 is used, the ten-key 60 is displayed by the ten-key display trigger (as shown in FIG. 9A). Next, when the thumb touches a location in the vicinity of the “5” key 65 of the ten-key 60, the first touch panel 11 of the electrostatic capacitance system performs a contact operation by detecting static electricity of the thumb. Then, the cursor indicating selection of the “5” key 65 as the input key is displayed (as shown in FIG. 9B). Next, when the whole belly of the thumb is touched on the first touch panel 11 in the vicinity of the “5” key 65, the cursor is displayed for each of the input keys in the neighborhood of the “5” key 65 as well (as shown in FIG. 9C). Next, when the whole belly of the thumb is moved to the upper end of the ten-key 60 while touching the first touch panel 11, the cursor is displayed for each of a plurality of the input keys in the vicinity of the upper end of the ten-key 60 (as shown in FIG. 9D). Next, the state of the touch is held without moving the thumb. Then, the “up” key 55 is displayed at the upper end of the ten-key 60 by the state holding trigger, and a cursor is also displayed (as shown in FIG. 9E). Next, when the state of the touch is held without moving the thumb, input of the “up” key 55 is determined by the state holding trigger (as shown in FIG. 9F). The number, the character, or the menu is selected on the display screen 32 of the first case 31 by the above-mentioned operations.

### Input of Menu Key

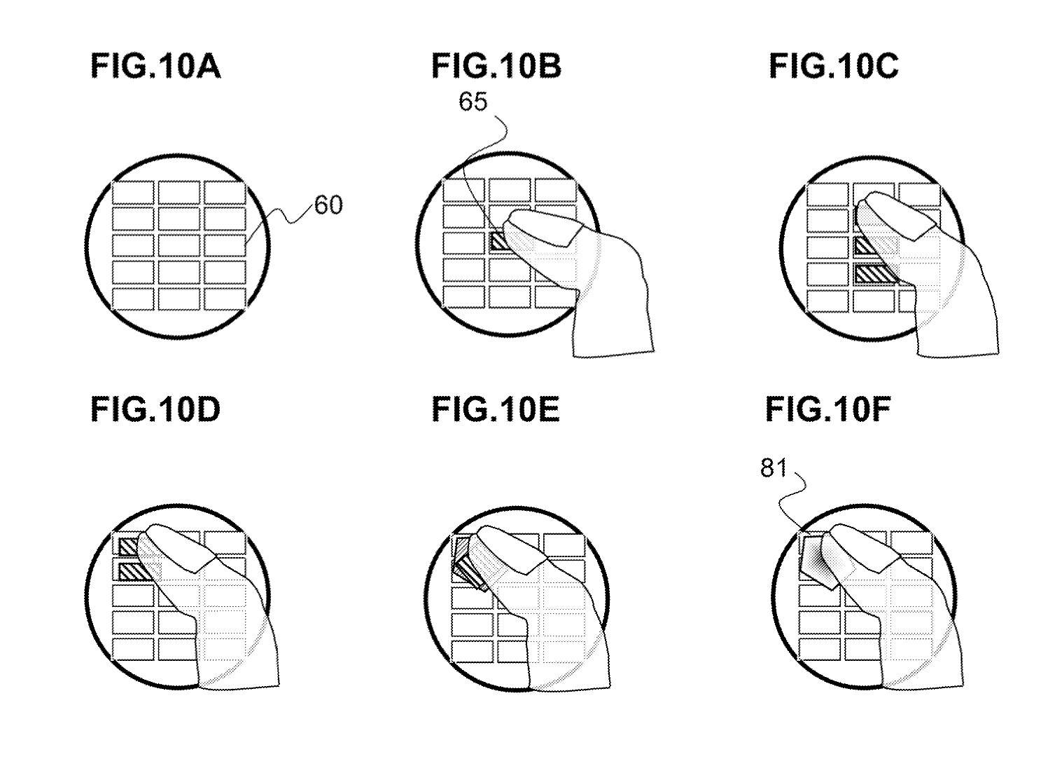

The operations when inputting the mail key 81 included in the menu key 80 in FIG. 6B will be described. The mail key 81 is a regular pentagon-shaped key displayed at an upper left end portion of the ten-key 60 in FIGS. 6B and 10A to 10F. When the menu key 80 is used, the ten-key 60 is displayed by the ten-key display trigger (as shown in FIG. 10A). Next, when the thumb touches a location in the vicinity of the “5” key 65 of the ten-key 60, the first touch panel of the electrostatic capacitance system performs a contact operation by detecting static electricity of the thumb. Then, the cursor indicating selection of the “5” key 65 as the input key is displayed for the “5” key 65 (as shown in FIG. 10B). Next, when the whole belly of the thumb is touched on the first touch panel 11 in the vicinity of the “5” key 65, the cursor is displayed for each of the input keys in the neighborhood of the “5” key 65 as well (as shown in FIG. 10C). Next, when the whole belly of the thumb is moved to the upper left end of the ten-key 60 while touching the first touch panel 11, the cursor is displayed for each of a plurality of the input keys in the vicinity of the upper left end of the ten-key 60 (as shown in FIG. 10D). Next, the state of the touch is held without moving the thumb. Then, the “mail” key 81 of the menu key 80 is displayed at the upper left end of the ten-key 60 by the state holding trigger, and a cursor is also displayed (as shown in FIG. 10E). Next, when the state of the touch is held without moving the thumb, input of the mail key 81 is determined by the state holding trigger (as shown in FIG. 10F). A mail menu is selected on the display screen 32 of the first case 31 by the above-mentioned operations.

### Triggers for Controlling Key Operations

As triggers (commands) for controlling operations of the ten-key 60, the determination key 52, the direction key 54, and the menu key 80, there are provided the ten-key display trigger and the state holding trigger.

The ten-key display trigger may be configured to be generated in the following manner, for example. The thumb touches on the first touch panel 11 in a state where the display unit 13 does not display the ten-key 60. Then, the first touch panel 11 of the electrostatic capacitance system performs a contact operation by detecting static electricity of the thumb. The ten-key display trigger is thereby generated.

On the other hand, the state holding trigger may be configured to be generated in the following manner, for example. The thumb is touched on the first touch panel 11 and is held in order to hold a state of selection of one of the input keys displayed on the display unit 13. Then, the contact operation of the first touch panel 11 of the electrostatic capacitance system is held for a given period of time. The state holding trigger is thereby generated.

After input of each of the ten-key 60, the determination key 52, the direction key 54, and the menu key 80 is determined, it is preferable that return to a ten-key display state (state where the ten-key 60 is displayed by the ten-key display trigger) be made. With this arrangement, successive operations on the input keys are enabled with the thumb kept touched on the first touch panel 11. That is, when the input keys are successively operated, an operation of sliding and stopping the thumb on the first touch panel 11 should be just repeated. Accordingly, an operation of depressing the input key and an operation of tapping the input key are not needed.

### Cancellation in the Course of Key Selection Operation

Detection of statistic electricity of the thumb is stopped by detaching the thumb from the first touch panel 11 in the course of an operation. The contact operation of the first touch panel 11 of the electrostatic capacitance system is thereby finished. All of key selection operations may be thereby canceled, and return to the ten-key display state (state where the ten-key 60 is displayed by the ten-key display trigger) may be made.

### Analog Pointer

An operation when slide-operating the input device 10, shown in FIG. 6C, will be described. Referring to FIG. 6C, the input device 10 is also the analog pointer 53. When the analog pointer 53 is used, the input device 10 is slid in an arbitrary direction in parallel with the key arrangement surface of the second case 30. At this point, the position of the permanent magnet 14 provided for the input device 10 is detected by the Hall effect device 42, and a pointer 33 of the display screen 32 of the first case 31 can be moved in an arbitrary direction. The elastomer member 20 heat welded to the housing 15, together the second board 41, are fixed to the second case 30 using screws. Thus, the input device 10 and the second case 30 are elastically connected by the elastomer member 20. Accordingly, the input device 10 can be slid in the arbitrary direction parallel to the key arrangement surface of the second case 30. The input device 10 will not get out of position from the second case 30. Further, since the housing 15 and the second board 41 are slightly in contact with each other, the input device 10 will not sink into the second case 30. Accordingly, the input device 10 can be smoothly slide-operated.

### Switching between Key Operation and Analog Pointer

When the ten-key 60, the determination key 52, the direction key 54, and the menu key 80 are operated, the thumb is slightly put on the first touch panel 11 and is then slid on the first touch panel 11. In this case, preferably, a sliding load necessary for sliding the thumb is set to a degree of several gf.

On the other hand, when the analog pointer 53 of the center key 51 is slide-operated, the thumb is strongly pressed against the first touch panel 11. Further, the thumb and the center key 51 provided for the first touch panel 11 is slid relative to the second case 30. In this case, preferably, a sliding load necessary for sliding the thumb is set to several 10 (tens) gf. With this arrangement, a user can make distinction between the operation for the ten-key 60 and the operation for the analog pointer 53.

### Effects

According to the input device 10 in this example, the following first to fourth effects are brought about.

As the first effect, the user can quickly perform input. The reason for the first effect is as follows. The center of the ten-key 60 and the determination key 52 are positioned at an almost same location. Accordingly, when input of a mail character is performed, a movement amount of the thumb that moves between the ten-key 60 and the determination key 52 can be reduced. Further, inputs are performed by repeating the operation of sliding and stopping the thumb on the first touch panel. Accordingly, the operation of depressing the input key and the operation of tapping the input key are not needed. Consequently, according to the input device 10 in this example, the area of a region where the input keys are arranged can be reduced. Further, according to the input device 10 in this example, movement of the finger necessary for input can be reduced, and quick input can be performed, as compared with a related art input device.

As the second effect, even if the skin of the thumb is dry, a slide operation of the center key 51 can be performed well. The reason for the second effect is as follows. The area of the first touch panel 11 of the input device 10 in this example is sufficiently larger than the area of a center key 151 in the related art input device. Accordingly, the slide operation of the input device 10 can be performed using the whole belly of the thumb. Consequently, even if the skin of the thumb is dry, a large friction force acts between the first touch panel 11 and the thumb.

As the third effect, when inputting one of the input keys located at an end of the cellular phone, the thumb readily reaches the input key, and insufficient gripping of the case that may occur when pressing the input key located at the end of the cellular phone is readily solved. It is therefore easy to press the input key. It is because all the input keys are put together at the display unit 13, and the area of the region where the keys are arranged is reduced. It is further because, since inputs are performed based on the operation of sliding and stopping the thumb on the first touch panel 11, no insufficient gripping of the case occurs.

As the fourth effect, the area of the key arrangement region can be reduced. It is because the center of a cross key 50 and the center of the ten-key 60 are set to be positioned at a same location.

A mechanism by which the above-mentioned first to fourth effects are brought about will be described below in further detail.

### First Effect

FIGS. 5B, 5C, 6A and 6B are diagrams for explaining reduction of a period of time necessary for an input operation by the cellular phone according to this first example. Referring to FIGS. 5B and 5C and 6A and 6B, the ten-key 60, the determination key 52, the direction key 54, and the menu key 80 are displayed on an inner side the display unit 13 of the input device 10 in the cellular phone according to this first example. The center of the ten-key 60 is disposed at the same location as the center of the determination key 52 on the key arrangement surface of the second case 30.

Let us consider the case where when inputting characters for a mail or the like, a selected item is determined by the determination key 52. First, the thumb is moved to the ten-key 60 to input the characters. After some characters have been input, the thumb is moved to the “5” key 65 at the center of the ten-key 60 in order to determine the input characters by the determination key 52. Next, the characters are determined by the determination key 52 displayed over the “5” key 65. The moving range of the thumb for the above-mentioned operations is limited to the inner side of the ten-key 60. Accordingly, the moving distance of the thumb that moves between the ten-key 60 and the determination key 52 becomes shorter than that in the related art cellular phone in which the determination key 152 is provided outside the ten-key 160. Consequently, according to the input device 10 in this example, a quick input operation becomes possible.

Next, let us consider the case where when inputting a character for a mail or the like, a selected item is displayed upwards by the direction key 54. First, the thumb is moved to the ten-key 60 and is then moved to the upper end of the ten-key 60 to input the direction key 54. Next, input is performed by the “up” key 55 of the direction key 54 displayed at the upper end of the ten-key 60. The moving range of the thumb for the above-mentioned operations is limited to the inner side of the ten-key 60. Accordingly, the moving distance of the thumb that moves between the ten-key 60 and the “up” key 55 of the direction key 54 becomes shorter than that in the related art cellular phone in which the “up” key of the direction key 154 is provided outside the ten-key 160. Consequently, according to the input device 10 in this example, a quick input operation becomes possible.

Next, let us consider the case where, when inputting a character for a mail or the like, a format for the input character is switched. First, the thumb is moved to the ten-key 60 and is then moved to the left upper end of the ten-key 60 to input the menu key 80. Next, the format for the input character is switched by the mail key 81 of the menu key 80 displayed at the upper left end of the ten-key 60. The moving range of the thumb for the above-mentioned operations is limited to the inner side of the ten-key 60. Accordingly, the moving distance of the thumb that moves between the ten-key 60 and the mail key 81 of the menu key 80 becomes shorter than that in the related art cellular phone in which the mail key of the menu key 180 is provided outside the ten-key 160. Consequently, according to the input device 10 in this example, operability of an input operation is improved, thus allowing quick input.

When successive inputs are performed, the thumb is first moved to one of the keys desired to be input within the region in which the ten-key 60 is disposed, and the key is input. Next, the thumb is moved to one of the keys desired to be input within the region in which the ten-key 60 is disposed, and the key is input. As described above, the inputs are performed by repeating the operation of sliding and stopping the thumb on the first touch panel 11. The operations of the thumb for the operation of the successive inputs are only movement and stopping of the thumb. Consequently, according to the input device 10 in this example, the number of steps of the operations is reduced from that of related art key inputs which need movement of the thumb, depression of the thumb, and detachment of the thumb. Consequently, according to the input device 10 in this example, operability of an input operation is improved, thus allowing quick input.

### Second Effect

FIG. 6C is a diagram for explaining operability of a slide operation of the input device 10 of the cellular phone according to this example. The first touch panel 11 in the cellular phone shown in FIG. 6C has a sufficiently large area as compared with the related art center key.

When the slide operation is performed, the thumb is first moved to above the first touch panel 11, and the first touch panel 11 is touched by the whole belly of the thumb. Next, the thumb is slid in an arbitrary direction in parallel with the key arrangement surface to slide the input device 10. Even if the skin of the thumb is dry in this case, a sufficiently large friction force acts between the first touch panel 11 and the thumb. Accordingly, operability of the slide operation of the input device 10 is improved, and slipping of the finger can be prevented.

### Third Effect

FIGS. 5B and 5C and FIGS. 6A and 6B are diagrams for explaining improvement of operability of an input operation of one of the input keys located at an end of the cellular phone according to this first example. Referring to FIGS. 5B and 5C and FIGS. 6A and 6B, all of the ten-key 60, the determination key 52, the direction key 54, and the menu key 80 are displayed on the display unit 13 of the input device 10. The area of the key arrangement region is reduced from that of the related art cellular phone.

When the menu key 80 located at the end of the cellular phone is input, the thumb is first moved to the region where the ten-key 60 is disposed, and is then moved to the upper left end of the ten-key 60 in order to input the menu key 80. Next, the mail key 81 of the menu key 80 displayed at the upper left end of the ten-key is input. The moving range of the thumb for the above-mentioned operations is limited to the inner side of the ten-key 60. Accordingly, the thumb fully reaches the menu key 80 displayed on the inner side the ten-key 60, and input is thereby facilitated.

At a time of the key input, the key input is performed by moving the thumb to the left upper end of the region where the ten-key 60 is displayed. The operations of the thumb included in the key input operation are only movement and stopping of the thumb. Consequently, insufficient gripping of the case which may occur when the thumb is detached from the touch panel in a related art key input that needs movement of the thumb, depression of the thumb, and detachment of the thumb can be avoided, and input of the input key located at the end of the cellular phone is thereby facilitated.

### Fourth Effect

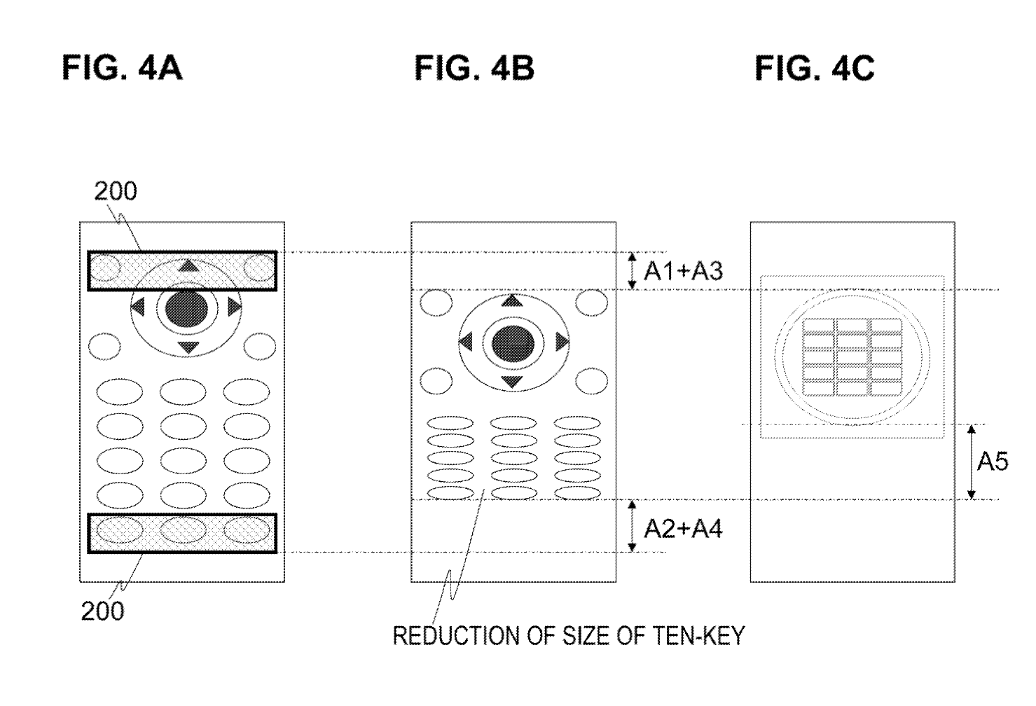

FIGS. 4A to 4C include diagrams for explaining the effect of reduction of the area of the region where the keys are arranged, which will be brought about by the cellular phone according to this example. FIG. 4A shows a related art cellular phone. FIG. 4B shows a cellular phone in which the size of the ten-key 60 is reduced, and arrangement of the cross key 50, the ten-key 60, and the menu key 80 is changed. FIG. 4C shows the cellular phone according to this example.

Referring to FIG. 4C, the ten-key 60, the determination key 52, the direction key 54, and the menu key 80 are all displayed within the display unit 13 of the input device 10. Accordingly, the area of the key arrangement region in the cellular phone in FIG. 4C is reduced from that of the cellular phone in FIG. 4A just by the width of (A1+A2+A3+A4+A5). The area of the key arrangement region in the cellular phone in FIG. 4C is reduced from that of the cellular phone in FIG. 4B just by the width of A5.

### SECOND EXAMPLE

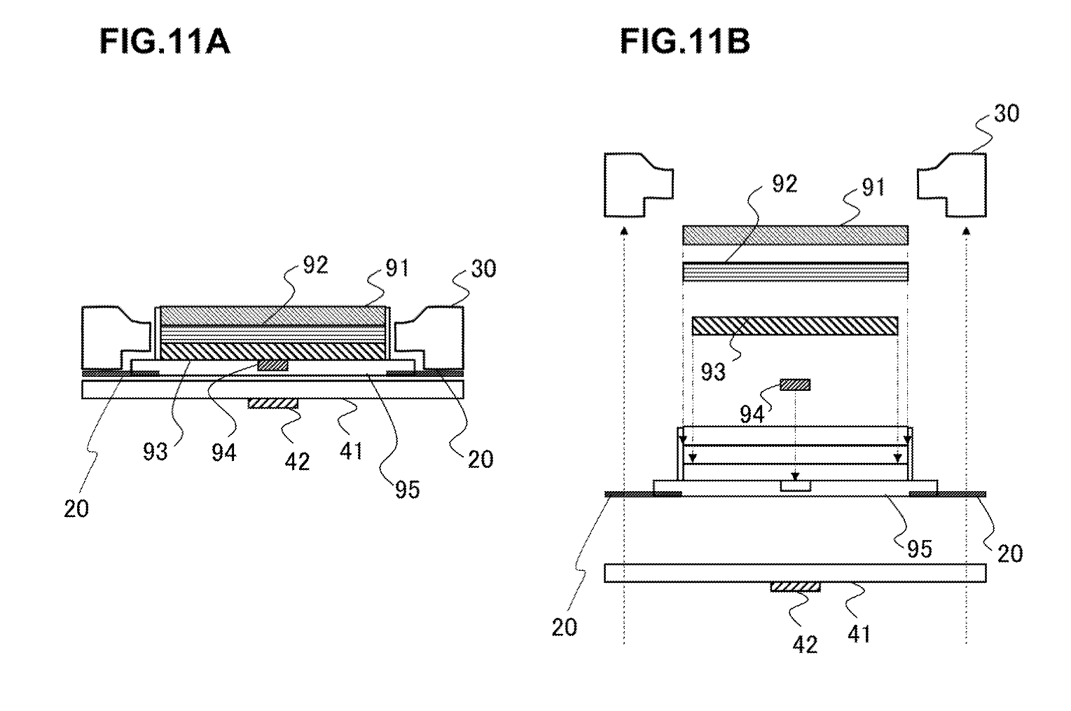

An input device according to a second example will be described with reference to the drawings. FIGS. 11A and 11B include a sectional view and an exploded view of a cellular phone for which the input device according to this example has been provided. FIG. 11A corresponds to the sectional view illustrating a section a5-a6 of the cellular phone shown in FIG. 3A. FIG. 11B is the exploded view of the cellular phone.

Referring to FIG. 11A, an input device 90 comprises a first touch panel 91, a second touch panel 92, a display unit 93, a permanent magnet 94, and a housing 95. The input device 90 in this example further includes the second touch panel (of a resistance film system) 92 between the first touch panel (of the electrostatic capacitance system) 11 and the display unit 13 of the input device 10 (in FIGS. 2A and 2B) in the first example.

FIGS. 3A, 3B, 3C, 11A, 11B, and FIGS. 12A to 15F are diagrams for explaining operations when keys of the cellular phone according to this example are operated.

When inputs of a ten-key 60, a determination key 52, a direction key 54, and a menu key 80 are determined, the ten-key 60, the determination key 52, the direction key 54, and the menu key 80 are respectively depressed. Then, a contact pressure of a thumb is detected, and the second touch panel 92 of the resistance film system performs a contact operation. Input of each of the ten-key 60, the determination key 52, the direction key 54, and the menu key 80 is thereby determined. The operations other than the above-mentioned determination operation are the same as those for the input device 10 in the first example.

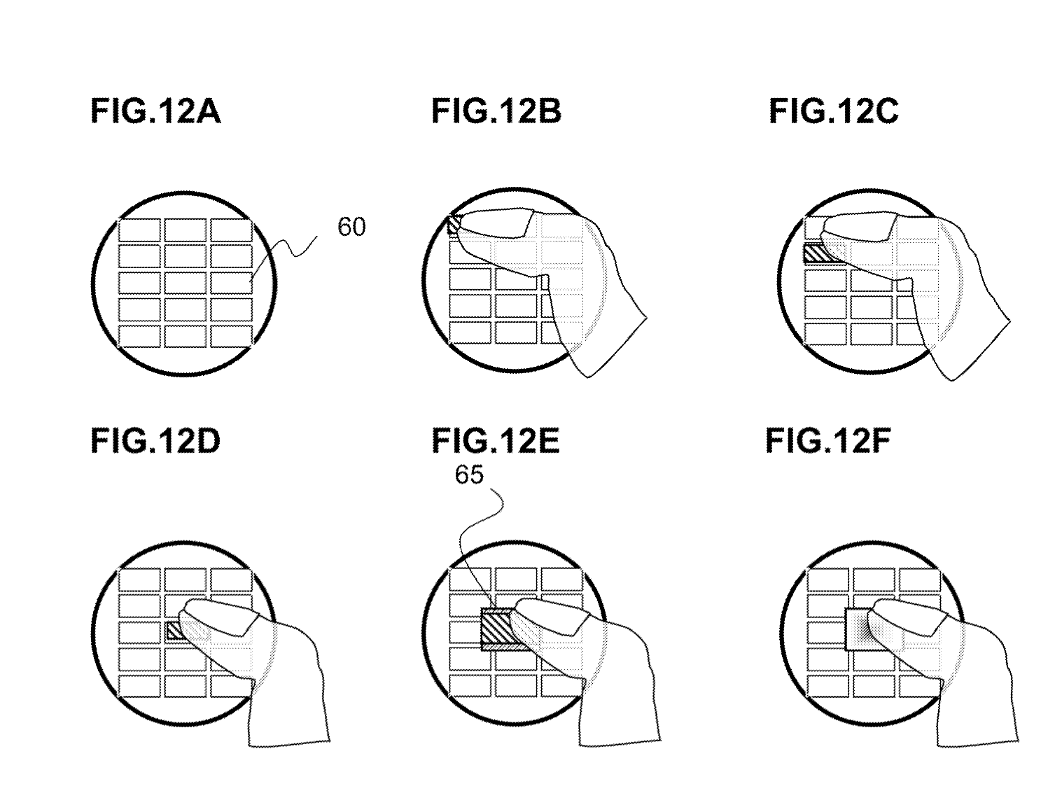

FIGS. 12A to 12F include diagrams for explaining the operations when the ten-key of the cellular phone in this example is operated. The operations shown in FIGS. 12A to 12E are the same as the operations (shown in FIGS. 7A to 7E) for the input device 10 in the first example. When an input key is determined in this example, a user depresses the first touch panel 91, and a change in pressure is detected by the second touch panel 92 (as shown in FIG. 12F).

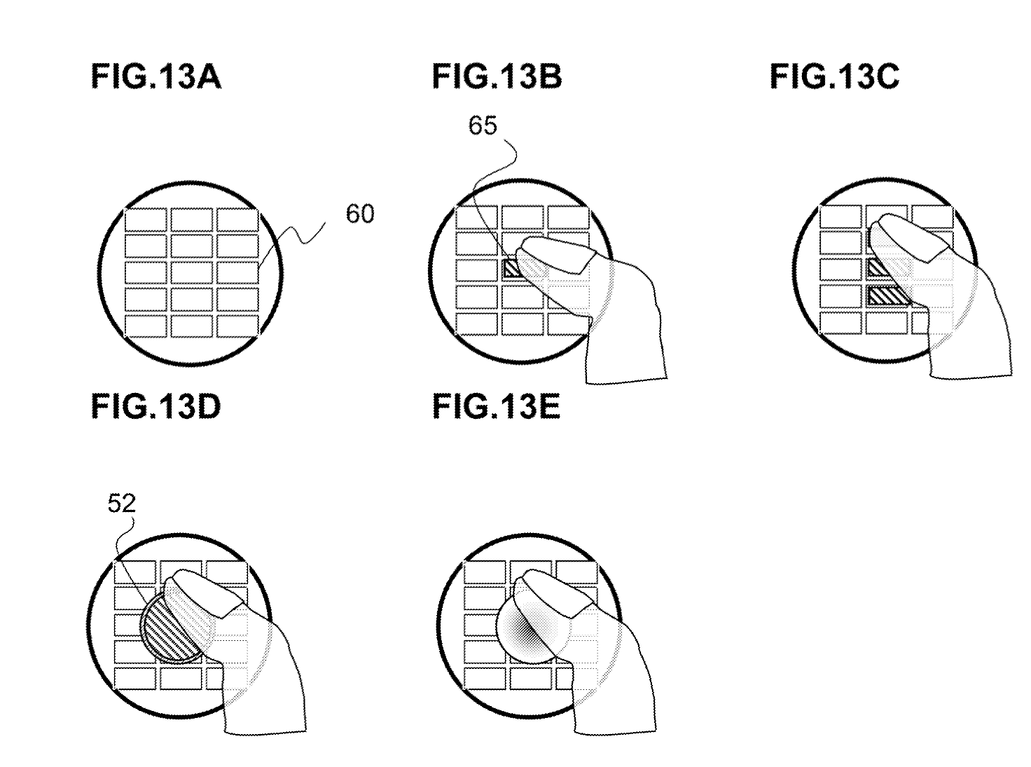

FIGS. 13A to 13E include diagrams for explaining the operations when the determination key 52 of the cellular phone according to this example is operated. The operations shown in FIGS. 13A to 13D are the same as the operations (shown in FIGS. 8A to 8D) for the input device 10 in the first example. When the input key is determined in this example, the user depresses the first touch panel 91 and a change in pressure is detected by the second touch panel 92 (as shown in FIG. 13E).

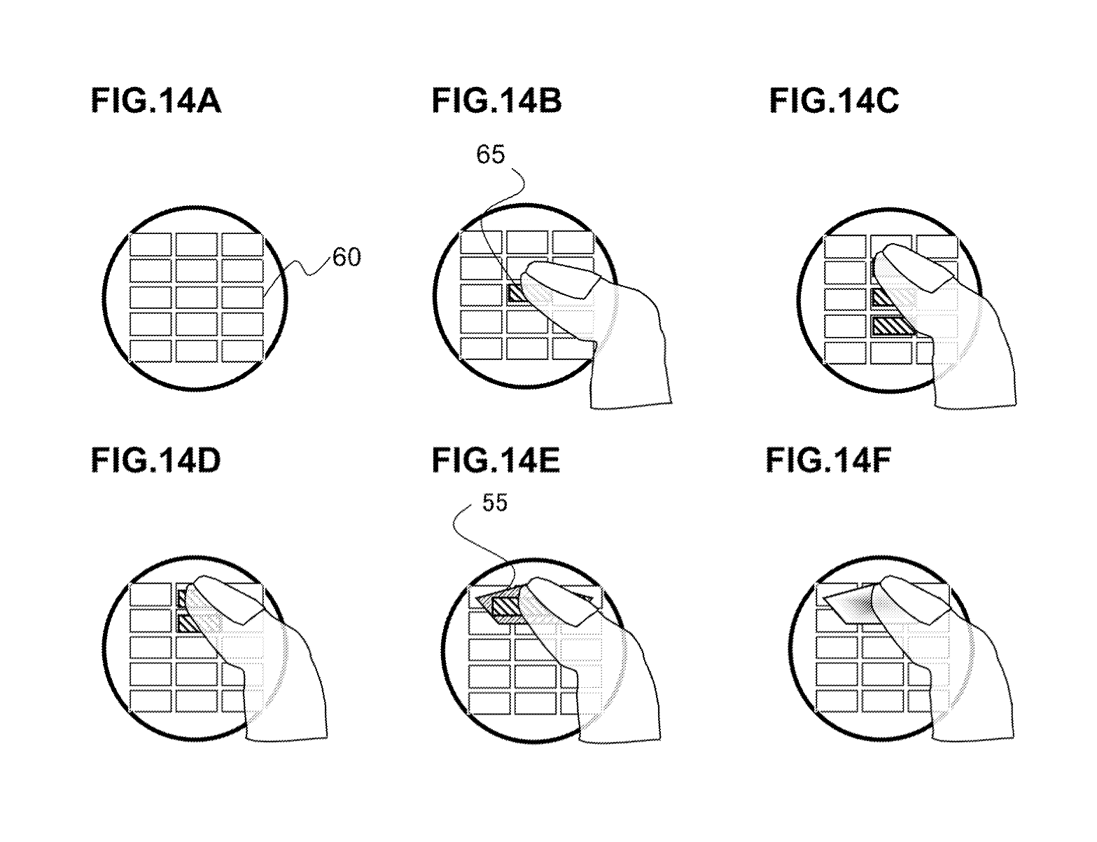

FIGS. 14A to 14F includes diagrams for explaining the operations when the direction key 54 of the cellular phone in this example is operated. The operations shown in FIGS. 14A to 14E are the same as the operations (shown in FIGS. 9A to 9E) for the input device 10 in the first example. When the input key is determined in this example, the user depresses the first touch panel 91, and a change in pressure is detected by the second touch panel 92 (as shown in FIG. 14F).

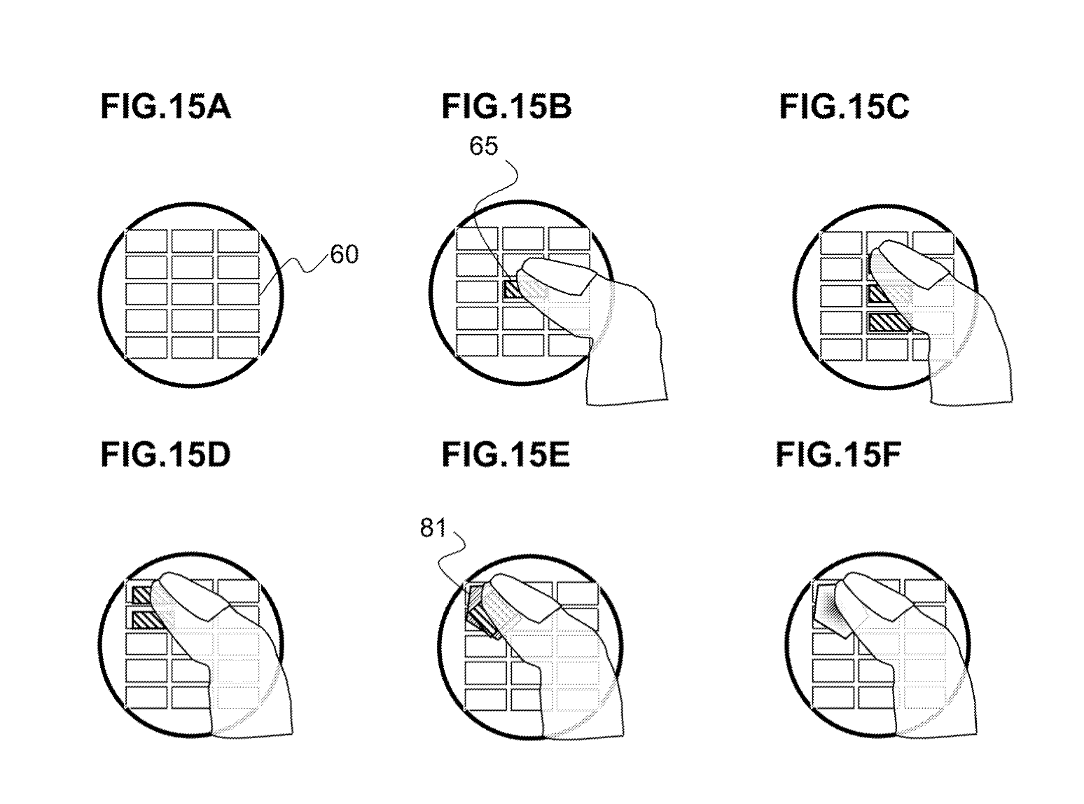

FIGS. 15A to 15F include diagrams for explaining the operations when the menu key of the cellular phone in this example is operated. The operations shown in FIGS. 15A to 15E are the same as the operations (shown in FIGS. 10A to 10E) for the input device 10 in the first example. When the input key is determined in this example, the user depresses the first touch panel 91, and a change in pressure is detected by the second touch panel 92 (as shown in FIG. 15F).

The above description was made, based on the examples. The present invention is not, however, limited to the examples mentioned above.

The analog pointer 53 in the first and second examples may be a “jog.” The analog pointer 53 may not be provided in the first and second example. In this case, the elastomer member 20 in the connecting portion may be omitted, and the second case 30 and the housing 15 (or 95) may be directly connected.

The direction key 54 in the first and second examples may be a “jog.”

The shape of each key top of the input device 10 (or 90) is not limited to a circle. The key top may have an arbitrary shape. The shape of the key top, for example, may be an ellipse, a triangle, a rectangle, a star shape, a shape with an outer periphery thereof composed of a curve, or a shape with an outer periphery thereof composed of a combination of a curve and a straight line.

The shape of each of the ten-key, the determination key, the direction key, and the menu key in the first and second examples may have an arbitrary shape. The shape of each of these keys, for example, may be a circle, an ellipse, a triangle, a rectangle, a star shape, a shape with an outer periphery thereof composed of a curve, or a shape with an outer periphery thereof composed of a combination of a curve and a straight line.

The contact system of each of the first touch panel 11 (or 91) and the second touch panel 92 in the first and second examples may be a resistance film system, an electrostatic capacitance system, an electromagnetic induction system, a surface acoustic wave system, or a piezoelectric system.

Key area expansion when operating the input key in the first and second examples is not limited to the ten-key. The expansion may be similarly performed for the input key such as the determination key, the direction key, or the menu key.

A position of the first touch panel 11 first touched by the thumb in the first and second examples when operating the input key is not limited to a location in the vicinity of the “5” key 65, and may be an arbitrary location.

Determination of input of the first touch panel 11 in the first and second examples may be an operation of touching the thumb on the first touch panel 11 and detaching the thumb from the first touch panel 11 (or a key depressing operation, or a key tapping operation).

The ten-key display trigger in the first and second examples is not limited to a touch of a finger on the first touch panel 11, and may be an operation of the analog pointer, side key input, or an operation of opening the case when the ten-key 60 is not displayed on the display unit 13.

The state holding trigger in the first and second examples is not limited to keeping a finger touched on the first touch panel 11, and may be slight movement of the finger in the arbitrary direction in parallel with the key arrangement surface.

In the first and second examples, the description was given, using the cellular phone as an example of a portable electronic apparatus. The input device according to the present invention can also be applied to a switch for a portable game apparatus, a portable computer, or a portable music player. The input device can also be applied to a remote controller switch of a desktop computer, a TV, a video player, or an air conditioner.

The input keys displayed on the display unit 13 (or 93) in the first and second examples are not limited to the ten-key 60, the determination key 52, the direction key 54, and the menu key 80, and may be set to keys corresponding to functions of a portable electronic apparatus including switches or a remote controller. A music play key or a video play key may be displayed on the display unit 13 as an example.

Each disclosure of Patent Document listed above and the like is incorporated herein by reference. Modifications and adjustments of the exemplary embodiment and the examples are possible within the scope of the overall disclosure (including claims) of the present invention, and based on the basic technical concept of the invention. Various combinations and selections of various disclosed elements are possible within the scope of the claims of the present invention. That is, the present invention of course includes various variations and modifications that could be made by those skilled in the art according to the overall disclosure including the claims and the technical concept.

A part or all of the above-mentioned exemplary embodiment may be described as the following further modes, but is not limited to these further modes.

### Further Mode 1

An input device for a portable electronic apparatus, comprising:

a display unit that displays a plurality of input keys;

a touch panel unit including at least one touch panel provided on the display unit; and

a control unit that controls and causes the display unit to display a second input key substantially at a same location as a first input key already displayed on the display unit in response to a predetermined input detected by the touch panel unit.

### Further Mode 2

The input device according to further mode 1, wherein:

the predetermined input is a touching or pressing on a predetermined location of the touch panel unit.

### Further Mode 3

The input device according to further mode 2, wherein:

the predetermined input is continuation of a touching or pressing on the predetermined location for a predetermined period of time.

### Further Mode 4

The input device according to further mode 1, wherein:

the predetermined input is a continuous touching or pressing from a first predetermined position to a second predetermined position on the touch panel unit.

### Further Mode 5

The input device according to any one of further modes 1 to 4, wherein:

the display unit performs superimposed display of the second input key on the first input key.

### Further Mode 6

The input device according to any one of further modes 1 to 4, wherein:

the display unit deletes display of the first input key and displays the second input key.

### Further Mode 7

The input device according to any one of further modes 1 to 6, wherein:

the touch panel unit comprises as a first touch panel an electrostatic-capacitive type touch panel.

### Further Mode 8

The input device according to further mode 7, wherein:

the control unit controls content of display on the display unit, based on an electrostatic capacitance detected by the first touch panel.

### Further Mode 9

The input device according to further mode 7 or 8, wherein:

the control unit determines selection of one of the input keys based on the electrostatic capacitance detected by the first touch panel.

### Further Mode 10

The input device according to any one of further modes 7 to 9, wherein:

the touch panel unit comprises as a second touch panel a pressure-sensitive type touch panel between the first touch panel and the display unit.

### Further Mode 11

The input device according to further mode 10, wherein:

the control unit controls the content of display on the display unit based on the electrostatic capacitance detected by the first touch panel and determines selection of the one of the input keys based on a change in pressure detected by the second touch panel.

### Further Mode 12

The input device according to any one of further modes 1 to 11, wherein:

the first input key is a ten-key; and

the second input key includes at least one of a determination key, a direction key, and a menu key.

### Further Mode 13

A portable electronic apparatus including the input device as set forth in any one of further modes 1 to 12.

### Further Mode 14

The portable electronic apparatus according to further mode 13, further comprising:

an elastic member connecting a main body of the apparatus and the input device, wherein:

the input device slides in a direction parallel to an installation surface of the input device.

### Further Mode 15

The portable electronic apparatus according to further mode 14, wherein:

the elastic member is an elastomer member.

### Further Mode 16

The portable electronic apparatus according to further mode 14 or 15, comprising:

a position detection unit that detects a position of the input device.

### Further Mode 17

The portable electronic apparatus according to further mode 16, wherein:

the position detection unit comprises a Hall effect device that detects a position of a magnet provided for the input device.

### Further Mode 18

A control method of an input device for a portable electronic apparatus comprising:

by a computer, detecting a predetermined input through a touch panel unit including at least one touch panel provided on a display unit that displays input keys; and

displaying a second input key substantially at a same location as a first input key already displayed on the display unit.

### Further Mode 19

The control method according to further mode 18, further comprising:

by the computer, controlling content of display on the display unit based on an electrostatic capacitance detected by a first touch panel that is an electrostatic-capacitive type touch panel included in the touch panel unit.

### Further Mode 20

The control method according to further mode 19, further comprising:

by the computer, determining selection of one of the input keys displayed on the display unit based on a change in pressure detected by a second touch panel that is a pressure-sensitive type touch panel provided between the first touch panel and the display unit.

### Further Mode 21

A program of controlling an input device for a portable electronic apparatus, the program causing a computer to execute:

detecting a predetermined input through a touch panel unit including at least one touch panel provided on a display unit that displays input keys; and

displaying a second input key substantially at a same location as a first input key already displayed on the display unit.

### Further Mode 22

The program according to further mode 21, wherein the program causes the computer to further execute:

controlling content of display on the display unit based on an electrostatic capacitance detected by a first touch panel that is an electrostatic-capacitive type touch panel included in the touch panel unit.

### Further Mode 23

The program according to further mode 22, wherein the program causes the computer to further execute:

determining selection of one of the input keys displayed on the display unit based on a change in pressure detected by a second touch panel that is a pressure-sensitive type touch panel provided between the first touch panel and the display unit.

### Further Mode 24

A computer-readable recording medium storing the program as set forth in any one of further modes 21 to 23.

### EXPLANATIONS OF SYMBOLS

10, 16, 90, 110 input device
11, 91 first touch panel
13, 17, 93 display unit
14, 94, 114 permanent magnet
15, 95 housing
18 touch panel unit
19 control unit
20, 120 elastomer member
30, 130 second case
31, 131 first case
32, 132 display screen
33, 133 pointer
41, 141 second board
42, 142 Hall effect device
50, 150 cross key
51, 151 center key
52, 152 determination key
53, 153 analog pointer
54, 154 direction key
55, 155 “up” key
56, 156 “down” key
57, 157 “left” key
58, 158 “right” key
60, 160 ten-key
61, 161 “1” key
62, 162 “2” key
63, 163 “3” key
64, 164 “4” key
65, 165 “5” key
66, 166 “6” key
67, 167 “7” key
68, 168 “8” key
69, 169 “9” key
70, 170 “0” key
71, 171 call key
72, 172 clear key
73, 173 power key
74, 174 “*” key
75, 175 “#” key
80, 180 menu key
81, 181 mail key
82, 182 Internet key
83, 183 first menu key
84, 184 second menu key
92 second touch panel
191 first board
192 metal dome
193 projection
200 end portion

What is claimed is:

1. An input device for a portable electronic apparatus, comprising:
a display unit that displays a plurality of input keys;
a touch panel unit including at least one touch panel provided on the display unit; and
a control unit that controls and causes the display unit to display a second input key substantially at a same location as a first input key already displayed on the display unit in response to a predetermined input detected by the touch panel unit.

2. The input device according to claim 1, wherein:
the predetermined input is a touching or pressing on a predetermined location of the touch panel unit.

3. The input device according to claim 2, wherein:
the predetermined input is continuation of the touching or pressing on the predetermined location for a predetermined period of time.

4. The input device according to claim 1, wherein:
the predetermined input is a continuous touching or pressing from a first predetermined position to a second predetermined position on the touch panel unit.

5. The input device according to claim 1, wherein:
the display unit performs superimposed display of the second input key on the first input key.

6. The input device according to claim 1, wherein:
the display unit deletes display of the first input key and displays the second input key.

7. The input device according to claim 1, wherein.
the touch panel unit comprises as a first touch panel an electrostatic-capacitive type touch panel.

8. The input device according to claim 7, wherein:
the control unit controls content of display on the display unit, based on an electrostatic capacitance detected by the first touch panel.

9. The input device according to claim 7, wherein:
the control unit determines selection of one of the input keys based on the electrostatic capacitance detected by the first touch panel.

10. The input device according to claim 7, wherein:
the touch panel unit comprises as a second touch panel a pressure-sensitive type touch panel between the first touch panel and the display unit.

11. The input device according to claim 10, wherein:
the control unit controls the content of display on the display unit based on the electrostatic capacitance detected by the first touch panel and determines selection of one of the input keys based on a change in pressure detected by the second touch panel.

12. The input device according to claim 1, wherein:
the first input key is a ten-key; and
the second input key includes at least one of a determination key, a direction key, and a menu key.

13. A portable electronic apparatus including the input device as set forth in claim 1.

14. The portable electronic apparatus according to claim 13, further comprising:
an elastic member connecting a main body of the apparatus and the input device, wherein:
the input device slides in a direction parallel to an installation surface of the input device.

15. The portable electronic apparatus according to claim 14, wherein:
the elastic member is an elastomer member.

16. The portable electronic apparatus according to claim 14, comprising:
a position detection unit that detects a position of the input device.

17. The portable electronic apparatus according to claim 16, wherein:
the position detection unit comprises a Hall effect device that detects a position of a magnet provided for the input device.

18. A control method of an input device for a portable electronic apparatus comprising:
by a computer, detecting a predetermined input through a touch panel unit including at least one touch panel provided on a display unit that displays input keys; and
displaying a second input key substantially at a same location as a first input key already displayed on the display unit.

19. The control method according to claim 18, further comprising:
by the computer, controlling content of display on the display unit based on an electrostatic capacitance detected by a first touch panel that is an electrostatic-capacitive type touch panel included in the touch panel unit.

20. The control method according to claim 19, further comprising:
by the computer, determining selection of one of the input keys displayed on the display unit based on a change in pressure detected by a second touch panel that is a pressure-sensitive type touch panel provided between the first touch panel and the display unit.

21. A non-transient recording medium recorded thereon a computer readable program of controlling an input device for a portable electronic apparatus, the program causing a computer to execute:
detecting a predetermined input through a touch panel unit including at least one touch panel provided on a display unit that displays input keys; and
displaying a second input key substantially at a same location as a first input key already displayed on the display unit.

22. The recording medium program according to claim 21, wherein the program causes the computer to further execute:
controlling content of display on the display unit based on an electrostatic capacitance detected by a first touch panel that is an electrostatic-capacitive type touch panel included in the touch panel unit.

23. The recording medium program according to claim 22, wherein the program causes the computer to further execute:
determining selection of one of the input keys displayed on the display unit based on a change in pressure detected by a second touch panel that is a pressure-sensitive type touch panel provided between the first touch panel and the display unit.
